(19) United States
(12) Patent Application Publication
(10) Pub. No.: US 2005/0118060 A1
(43) Pub. Date: Jun. 2, 2005

(54) Multi-well container positioning devices and related systems and methods

(75) Inventor: Douglas Evans, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC, Hamilton HM LX (BM)

(21) Appl. No.: 10/911,238

(22) Filed: Aug. 3, 2004

Related U.S. Application Data
(60) Provisional application No. 60/492,586, filed on Aug. 4, 2003.

(51) Int. Cl. G01N 35/00

(52) U.S. Cl. 422/63

(57) ABSTRACT

The present invention provides positioning devices the include one or more container stations that each comprise a support surface that is structured to position at least one multi-well container. Container stations are tiered relative to one another and/or rotationally coupled to support structures of the positioning devices. The invention also relates to systems and methods that include the positioning devices described herein.

### CROSS-REFERENCES TO RELATED APPLICATIONS

This application claims the benefit of U.S. Provisional Application No. 60/492,586, filed Aug. 4, 2003, the disclosure of which is incorporated by reference in its entirety for all purposes.

### COPYRIGHT NOTIFICATION

Pursuant to 37 C.F.R. §1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### FIELD OF THE INVENTION

The present invention relates generally to object positioning, and more particularly, to devices, automated systems, and methods for positioning multi-well containers for additional processing, including material transfer and assay detection.

### BACKGROUND OF THE INVENTION

To enhance the throughput of chemical synthesis and compound screening, these processes are often performed in parallel utilizing various multi-well container formats. Multi-well containers, such as microtiter plates typically have many individual sample wells, for example, hundreds or even thousands of wells. Each well forms a container into which a sample or reagent is placed. Since an assay or synthesis can be conducted in each sample well, hundreds or thousands of assays or syntheses can be performed simultaneously using a single plate. Many commercially available microtiter plates are configured to meet industry standards in terms of well numbers (e.g., 96 wells, 384 wells, 1536 wells, and even higher well densities), well proportions, and overall plate dimensions. In addition, coupling the use of multi-well containers with automated processing systems typically further increases the number of compounds that can be synthesized and/or tested in a single day. To illustrate, automated equipment, such as automated material handling devices can receive appropriately configured multi-well containers and deposit samples or reagents into the wells. Other known automated equipment, such as robotic translocation devices can also facilitate the processing and testing of samples in multi-well containers.

In order to perform a high throughput assay with a high degree of reliability and repeatability, a high throughput system generally needs to accurately, quickly, and reliably position individual multi-well containers for processing. For example, multi-well containers must typically be placed precisely relative to material handling devices, such as liquid dispensers to allow the liquid dispenser to deposit samples or reagents into the correct sample wells. A positioning error of only a few thousandths of an inch can result in a sample or reagent being dispensed into a wrong sample well. Such a mistake can lead to biased test results, which may be relied upon for critical decision making, such as a course of medical treatment for a patient. Further, even a minor positioning error may cause a needle or tip of the liquid dispenser to collide with a multi-well container surface, which can damage the liquid dispenser and the multi-well container.

Many conventional automated positioning devices lack sufficient positioning accuracy and precision to reliably and repeatably position high-density multi-well containers for automated processing. For example, typical robotic systems are generally capable of achieving a positioning tolerance of about one mm. Although such a tolerance is adequate for certain low well density containers, such a tolerance is often inadequate for high density containers, such as a microtiter plate with 1536 or more wells. For example, a positioning error of one mm for a 1536-well microtiter plate could cause a sample or reagent to be deposited entirely in the wrong well, or cause damage to system components, such as liquid dispenser needles, tips, or pins.

Due to the multi-well container positioning imprecision of many conventional positioning systems, additional precautions are generally taken to avoid undesired test results. For example, tests or screens may be performed using manual intervention to assure that containers are properly positioned prior to performing a task that demands high precision, such as dispensing sample or reagent into sample wells. Such manual intervention typically dramatically slows the overall process and is often not highly reproducible due to errors associated with human handling.

As an alternative, assays may be performed using lower well-density containers. The well dimensions of lower density containers are typically large enough such that even conventional automated systems are more likely to process the correct wells. For example, assays are optionally performed using a plate with only 96 wells, rather than one with 1536 wells. The lower number of sample wells typically reduces the minimum accuracy threshold, and the repeatability and reliability of the test may be improved. However, by using containers with fewer wells, the overall assay throughput is typically limited. Further, the cost attributable to each assay is generally significantly increased, as the larger wells of the lower-density containers often require the use of larger quantities of reagents.

In another effort to achieve reliability in conventional systems, several sample wells in a given multi-well container may be utilized as control wells. These wells are typically selected such that if a step of the automated process is completed while the container is mispositioned, the control well receives a particular known sample or reagent. At a later stage in the process, the control wells are analyzed to determine if the particular known sample or reagent was introduced into the control well. If so, the microtiter plate will be identified as having been mishandled and may be appropriately eliminated from further consideration. Although such a system offers some assurance of the assay reliability, the throughput for the entire process is reduced at least by the number of wells diverted to use as controls. Moreover, positioning errors are typically not detected until the processing cycle has proceeded further downstream, which wastes valuable system resources for the continued processing of a mishandled sample container.

From the foregoing, it is apparent that devises that can be utilized to precisely and accurately position multi-well sample containers for processing are highly desirable. In addition, automated systems that include these devices and related methods of positioning multi-well containers are also desirable. These and a variety of additional features of the present invention will be evident upon complete review of the following disclosure.

### SUMMARY OF THE INVENTION

The present invention relates generally to positioning devices for positioning multi-well containers in desired positions with greater precision and accuracy than many preexisting devices. Positioning precision and accuracy are often threshold considerations in determining whether a container of a given well density can be utilized in a particular system and/or process. Assay throughput is often limited by devices that cannot precisely and accurately position higher well density containers, such as those including over 1000 wells. In the present invention, the positioning devices include container stations that are structured to position essentially any multi-well container, including such high density containers. In certain embodiments, for example, container stations include alignment members for aligning multi-well containers and are tiered relative to one another in a given positioning device such that containers positioned in different tiered stations are accessible by, e.g., robotic translocation devices without contacting one another. In some embodiments, container stations are rotationally coupled to support structures of positioning devices to adjust multi-well container positions. In other embodiments, tiered container stations having alignment members are also rotationally coupled to device support structures. The invention further provides automated systems that include these positioning devices. The systems of the invention include material handling devices for dispensing and/or removing materials from selected wells disposed in multi-well containers positioned in the positioning devices of the systems. The systems of the invention also typically include various additional components for performing many different types of chemical syntheses, compound screening, and other processes. In addition, the invention also provides methods of positioning multi-well containers in the devices of the invention for additional processing, including material transfer and assay detection.

In one aspect, the invention relates to a positioning device that includes a support structure having two or more container stations. Each container station includes a support surface that is structured to position at least one multi-well container in which wells of multi-well containers positioned in two or more of the container stations are accessible substantially simultaneously (e.g., along planes that are substantially perpendicular to top surfaces of the containers). In addition, at least two of the container stations are tiered relative to one another. Among the advantages of this tiered orientation are that one or more multi-well containers positioned in one tiered container station are accessible (e.g., by a robotic translocation device, etc.) at least along a plane that is substantially parallel to top surfaces of the multi-well containers without contacting one or more other multi-well containers positioned in another tiered container station. In certain embodiments, the positioning device further includes at least one position sensor coupled to the support structure that is structured to detect the position of one or more multi-well containers when the multi-well containers are positioned in at least one of the container stations and/or to detect the position of at least one component of the positioning device.

The container stations of the invention include various embodiments. For example, at least one of the container stations optionally includes at least one orifice disposed through the positioning device such that electromagnetic energy is receivable by and/or from at least a portion of one or more multi-well containers through the orifice when the multi-well containers are positioned in the container station, e.g., as part of an assay detection process. In some embodiments, at least one of the container stations includes a heating element that adjustably regulates temperature in one or more multi-well containers when the multi-well containers are positioned in the container station and the heating element is operably connected to a power source. In other embodiments, at least one of the container stations is coupled to the support structure by a rotational coupling such that the container station is rotatable on the rotational coupling about at least one rotational axis. In these embodiments, the positioning device typically further includes at least one rotational adjustment feature coupled to the support structure. The rotational adjustment feature engages the container station to adjustably rotate the container station about the rotational axis.

Typically, at least a first of the container stations comprises at least one alignment member that is positioned to engage an inner wall of an alignment member receiving area of at least a first multi-well container when the first multi-well container is on the support surface of the first container station. In certain embodiments, the first container station includes multiple alignment members extending from the support surface of the first container station. In these embodiments, at least two of the alignment members are typically positioned to engage different inner walls of the alignment member receiving area of the first multi-well container when the first multi-well container is positioned in the first container station. In some embodiments, the first container station comprises multiple alignment members that together form a nest that is structured to receive the first multi-well container when the first multi-well container is positioned in the first container station. In these embodiments, at least one of the multiple alignment members generally includes an angled surface that is configured to direct the first multi-well container into the nest when the first multi-well container is placed into the nest. Optionally, the alignment member includes a curved surface that is structured to engage the inner wall of the alignment member receiving area of the first multi-well container. To illustrate, the alignment member optionally comprises a locating pin that extends from the support surface of the first container station.

In some embodiments, at least one of the container stations further includes one or more openings disposed in the support surface of the container station through which a vacuum is applied to hold one or more multi-well containers in desired positions when the openings are operably connected to a vacuum source and the multi-well containers are positioned in the container station. In these embodiments, the container station optionally includes an interior surface and a lip surface, with the interior surface being recessed relative to the lip surface. For example, the depth at which the interior surface is recessed is generally between 0.001 inches and 0.01 inches. Optionally, a support matrix approximately as thick as the depth at which the interior surface is recessed is present on the interior surface to prevent distortion of the multi-well containers when the vacuum is applied by the vacuum source. In certain of these embodiments, the positioning device further includes a vacuum-actuated switch that generates a signal that indicates the multi-well containers are properly positioned when the multi-well containers form airtight seals with the container station. In these embodiments, the positioning device typically further comprises at least one controller operably connected to the vacuum-actuated switch in which the signal notifies the controller that the multi-well containers are ready for further processing.

The positioning device of the invention optionally further includes one or more pushers coupled to the support structure, which pushers are configured to push the first multi-well container into contact with the alignment member when the first multi-well container is positioned in the first container station. Typically, multiple pushers are coupled to the support structure in which at least two of the pushers are configured to push the first multi-well container in different directions, e.g., to contact different alignment members. In these embodiments, the positioning device generally further includes at least one controller operably connected to at least one of the pushers. The controller typically directs the pusher to push the first multi-well container into contact with the alignment member when the first multi-well container is positioned in the first container station. Optionally, at least one of the pushers comprises a low friction contact point (e.g., a roller, etc.) that is structured to contact the first multi-well container when the first multi-well container is positioned in the first container station. In some of these embodiments, the positioning device further includes at least one lever arm pivotally coupled to the support structure by a pivotal coupling. In these embodiments, at least a first of the pushers is configured to push the lever arm such that the lever arm pivots to push the first multi-well container into contact with the alignment member when the first multi-well container is positioned in the first container station. The lever arm is optionally coupled to a resilient coupling (e.g., a spring, etc.) that causes the first pusher to apply a constant force to the first multi-well container in order to push the first multi-well container in a first direction when the first multi-well container is positioned in the first container station.

In another aspect, the present invention provides a positioning device that includes a support structure having one or more container stations that each includes a support surface that is structured to position at least one multi-well container. At least one of the container stations is coupled to the support structure by a rotational coupling such that the container station is rotatable on the rotational coupling about at least one rotational axis. In preferred embodiments, the positioning device further includes at least one rotational adjustment feature coupled to the support structure, which rotational adjustment feature engages the rotationally coupled container station to adjustably rotate the rotationally coupled container station about the rotational axis. Typically, at least a first of the container stations comprises at least one orifice disposed through the positioning device such that electromagnetic energy is receivable by and/or from at least a portion of a first multi-well container through the orifice when the first multi-well container is positioned in the first container station, e.g., for assay detection. In some embodiments, at least a first of the container stations includes a heating element that adjustably regulates temperature in a first multi-well container when the first multi-well container is positioned in the first container station and the heating element is operably connected to a power source. In certain embodiments, the positioning device further includes at least one position sensor coupled to the support structure that is structured to detect the position of one or more multi-well containers when the multi-well containers are positioned in at least one of the container stations and/or to detect the position of at least one component of the positioning device. In some embodiments, the positioning device includes multiple container stations in which at least two of the multiple container stations are tiered relative to one another such that a first multi-well container positioned in one tiered container station is accessible (e.g., by a robotic translocation device, etc.) at least along a plane that is substantially parallel to a top surface of the first multi-well container without contacting a second multi-well second container positioned in another tiered container station.

In preferred embodiments, at least a first of the container stations includes at least one alignment member that is positioned to engage at least one surface of at least a first multi-well container when the first multi-well container is positioned in the first container station. The first container station typically includes multiple alignment members extending from the support surface of the first container station in which at least two of the alignment members are positioned to engage different surfaces of the first multi-well container when the first multi-well container is positioned in the first container station. In certain embodiments, the alignment member is positioned to engage an inner wall of an alignment member receiving area of the first multi-well container.

In some embodiments, the first container station includes multiple alignment members that form a nest that is structured to receive the first multi-well container when the first multi-well container is positioned in the first container station. Typically, at least one of the multiple alignment members includes an angled surface that is configured to direct the first multi-well container into the nest when the first multi-well container is placed into the nest. In preferred embodiments, all alignment members of a given nest include these angled surfaces. In other embodiments, the alignment member includes a curved surface that is structured to engage the inner wall of the alignment member receiving area of the first multi-well container. In some of these embodiments, for example, the alignment member includes a locating pin that extends from the support surface of the first container station.

The positioning device optionally further includes one or more pushers coupled to the support structure, which pushers are configured to push the first multi-well container into contact with the alignment member when the first multi-well container is positioned in the first container station. Typically, multiple pushers are coupled to the support structure in which at least two of the pushers are configured to push the first multi-well container in different directions. In these embodiments, the positioning device typically further includes at least one controller operably connected to at least one of the pushers, which controller directs the pusher to push the first multi-well container into contact with the alignment member when the first multi-well container is positioned in the first container station. Optionally, at least one of the pushers includes a low friction contact point (e.g., a roller, etc.) that is structured to contact the first multi-well container when the first multi-well container is positioned in the first container station. In these embodiments, the positioning device optionally further includes at least one lever arm pivotally coupled to the support structure by a pivotal coupling. At least a first of the pushers is generally configured to push the lever arm such that the lever arm pivots to push the first multi-well container into contact with the alignment member when the first multi-well container is positioned in the first container station. In some embodiments, the lever arm is coupled to a resilient coupling (e.g., a spring, etc.) that causes the first pusher to apply a constant force to the first multi-well container in order to push the first multi-well container in a first direction when the first multi-well container is positioned in the first container station.

In certain embodiments, at least a first of the container stations further includes one or more openings disposed in the support surface of the first container station through which a vacuum is applied to hold a first multi-well container in a desired position when the openings are operably connected to a vacuum source and the first multi-well container is positioned in the first container station. In some of these embodiments, the first container station includes an interior surface and a lip surface, with the interior surface being recessed relative to the lip surface. For example, the depth at which the interior surface is recessed is between 0.001 inches and 0.01 inches. Optionally, a support matrix approximately as thick as the depth at which the interior surface is recessed is present on the interior surface to prevent distortion of the first multi-well container when a vacuum is applied by the vacuum source. In certain embodiments, the positioning device further includes a vacuum-actuated switch that generates a signal that indicates the first multi-well container is properly positioned when the first multi-well container forms an airtight seal with the first multi-well container. In these embodiments, the positioning device further includes at least one controller operably connected to the vacuum-actuated switch in which the signal notifies the controller that the multi-well containers are ready for further processing.

In still another aspect, the present invention relates to an automated system. The system includes at least one positioning device that includes a support structure having two or more container stations that each comprises a support surface that is structured to position at least one multi-well container in which wells of multi-well containers positioned in two or more of the container stations are accessible substantially simultaneously. In addition, at least two of the container stations are tiered relative to one another. The system also includes at least one material handling device. In addition, the system also includes at least one controller operably connected to the material handling device. The material handling device typically includes a fluid handling device (e.g., a pin tool, a pipettor, and/or the like). The controller directs the material handling device to dispense material into and/or remove material from selected wells of one or more multi-well containers when the multi-well containers are positioned in one or more container stations of the positioning device.

Typically, at least a first of the container stations includes at least one alignment member. In some embodiments, the positioning device of the system optionally further includes at least one pusher coupled to the support structure and operably connected to the controller. In these embodiments, the controller typically further directs the pusher to push at least a first multi-well container into contact with the alignment member when the first multi-well container is positioned in the first container station. In some embodiments, at least one of the container stations includes one or more openings disposed in the container station and the system further includes at least one vacuum source operably connected to the openings. The vacuum source typically applies a vacuum at the openings to hold at least one selected multi-well container in a desired position when the selected multi-well container is in the container station. In these embodiments, the controller is generally further operably connected to the vacuum source to regulate the vacuum applied by the vacuum source.

In certain embodiments, at least one of the container stations is coupled to the support structure by a rotational coupling such that the container station is rotatable on the rotational coupling about at least one rotational axis. In these embodiments, the automated system optionally further includes at least one rotational adjustment feature coupled to the support structure. The rotational adjustment feature engages the rotationally coupled container station to adjustably rotate the rotationally coupled container station about the rotational axis. The controller is typically further operably connected to the rotational adjustment feature to further direct the rotational adjustment feature to adjustably rotate the rotationally coupled container station.

The automated systems of the invention generally include various additional components. For example, the automated system optionally further includes at least one robotic translocation device operably connected to the controller, which controller further directs the robotic translocation device to translocate selected multi-well containers to and/or from selected container stations. In some embodiments, the automated system further includes at least one detector operably connected to the controller, which controller further directs the detector to detect one or more detectable signals produced in one or more selected wells of one or more multi-well containers when the multi-well containers are positioned in one or more container stations of the positioning device. In certain embodiments, the automated system further includes at least one multi-well container washing device (e.g., a non-invasive multi-well container washing device, etc.) operably connected to the controller. In these embodiments, the controller further directs the multi-well container washing device to wash one or more selected wells of at least a first multi-well container when the first multi-well container is positioned in at least a first container station. In some embodiments, the automated system further includes at least one translational mechanism coupled to the positioning device, which translational mechanism is structured to translate the positioning device along at least one translational axis, e.g., such that the positioning device can be moved relative to a robotic translation device or the like.

In yet another aspect, the invention relates to an automated system that includes at least one positioning device comprising a support structure having one or more container stations that each comprises a support surface that is structured to position at least one multi-well container. At least one of the container stations is coupled to the support structure by a rotational coupling such that the container station is rotatable on the rotational coupling about at least one rotational axis. The automated system also includes at least one material handling device. The material handling device optionally includes a fluid handling device (e.g., a pin tool, a pipettor, and/or the like). In addition, the system also includes at least one controller operably connected to the material handling device. The controller directs the material handling device to dispense material into and/or remove material from selected wells of one or more multi-well containers when the multi-well containers are positioned in selected container stations of the positioning device.

In certain embodiments, the positioning device further includes at least one alignment member extending from the support surface of at least a first container station and at least one pusher coupled to the support structure. The pusher is typically operably connected to the controller, which controller further directs the pusher to push at least a first multi-well container into contact with the alignment member when the first multi-well container is positioned in the first container station. In some embodiments of the invention, at least a first of the container stations comprises one or more openings disposed in the first container station and the system further includes at least one vacuum source operably connected to the openings. The vacuum source applies a vacuum at the openings to hold at least a first multi-well container in a desired position when the first multi-well container is in the first container station. In these embodiments, the controller is typically further operably connected to the vacuum source to regulate the vacuum applied by the vacuum source. Optionally, the automated system further includes at least one rotational adjustment feature coupled to the support structure, which rotational adjustment feature engages the rotationally coupled container station to adjustably rotate the rotationally coupled container station about the rotational axis. In these embodiments, the controller is typically further operably connected to the rotational adjustment feature to further direct the rotational adjustment feature to adjustably rotate the rotationally coupled container station.

The automated system optionally includes various additional components. In some embodiments, for example, the automated system further includes at least one robotic translocation device operably connected to the controller. The controller further directs the robotic translocation device to translocate selected multi-well containers to and/or from selected container stations. In other embodiments, the system further comprises at least one detector operably connected to the controller. In these embodiments the controller further directs the detector to detect one or more detectable signals produced in one or more selected wells of at least a first multi-well container when the first multi-well container is positioned in at least a first container station of the positioning device. In some embodiments, the automated system further includes at least one multi-well container washing device (e.g., a non-invasive multi-well container washing device, etc.) operably connected to the controller. In these embodiments, the controller further directs the multi-well container washing device to wash one or more selected wells of at least a first multi-well container when the first multi-well container is positioned in at least a first container station. In certain embodiments, the automated system further includes at least one translational mechanism coupled to the positioning device, which translational mechanism is structured to translate the positioning device along at least one translational axis.

In one aspect, the invention provides a method of positioning a multi-well container. The method includes (a) providing a positioning device comprising a support structure having one or more container stations that each comprises a support surface that is structured to position at least one multi-well container. At least one of the container stations is coupled to the support structure by a rotational coupling such that the container station is rotatable on the rotational coupling about at least one rotational axis. The method also includes (b) placing the multi-well container in the rotationally coupled container station, and (c) rotating the rotationally coupled container station about the rotational axis to a selected position, thereby positioning the multi-well container. In some embodiments, (b) comprises placing the multi-well container in the rotationally coupled container station with a robotic translocation device, whereas in others (b) comprises manually placing the multi-well container in the rotationally coupled container station.

In certain embodiments, one or more openings are disposed in the rotationally coupled container station and at least one vacuum source is operably connected to the openings. In these embodiments, the method typically further comprises applying a vacuum at the openings with the vacuum source to hold the multi-well container in the rotationally coupled container station. In certain other embodiments, the positioning device further comprises at least one pusher and the rotationally coupled container station further comprises at least one alignment member. In these embodiments the method generally further comprises pushing the multi-well container into contact with the alignment member with the pusher to align the multi-well container in the rotationally coupled container station. Optionally, the method further includes placing at least one other multi-well container in at least one other container station of the positioning device. In some embodiments, the method further includes dispensing material into and/or removing material from selected wells of the multi-well container with a material handling device. In certain embodiments, the method further includes detecting one or more detectable signals produced in one or more selected wells of the multi-well container with a detector.

In another aspect, the invention relates to a method of positioning a multi-well container that includes (a) providing a positioning device that comprises a support structure having at least one pusher coupled to the support structure and two or more container stations that each comprises a support surface that is structured to position at least one multi-well container. At least a first of the container stations comprises at least one alignment member, and at least two of the container stations are tiered relative to one another. The method also includes (b) placing the multi-well container in the first container station, and (c) pushing the multi-well container into contact with the alignment member with the pusher, thereby positioning the multi-well container. In some embodiments, (b) comprises placing the multi-well container in the first container station with a robotic translocation device, whereas in others (b) comprises manually placing the multi-well container in the first container station.

In some embodiments, one or more openings are disposed in the first container station and at least one vacuum source is operably connected to the openings. In these embodiments, the method generally further comprises applying a vacuum at the openings with the vacuum source to hold the multi-well container in the first container station. The method optionally further includes placing at least one other multi-well container in at least a second of the container stations of the positioning device. In some embodiments, the method further includes dispensing material into and/or removing material from selected wells of the multi-well container with a material handling device. In certain embodiments, the method further includes detecting one or more detectable signals produced in one or more selected wells of the multi-well container with a detector.

### BRIEF DESCRIPTION OF THE DRAWINGS

FIG. 1 schematically shows an automated system from a perspective view according to one embodiment of the invention.

FIG. 2 schematically depicts a support structure of a positioning device from a bottom view according to one embodiment of the invention.

FIG. 3A schematically shows a front foot of a positioning device from a detailed bottom view according to one embodiment of the invention.

FIG. 3B schematically illustrates the front foot of FIG. 3A from a detailed side view.

FIG. 3C schematically illustrates the front foot of FIG. 3A from a detailed top view.

FIG. 4A schematically shows a rear foot of a positioning device from a detailed top view according to one embodiment of the invention.

FIG. 4B schematically illustrates the rear foot of FIG. 4A from a detailed side view.

FIG. 4C schematically illustrates the rear foot of FIG. 4A from a detailed bottom view.

FIG. 5A schematically shows a side view of the support structure shown in FIG. 2.

FIG. 5B schematically illustrates a cross-sectional side view of the support structure shown in FIG. 2.

FIG. 6A schematically shows the support structure shown in FIG. 2 from a top view.

FIG. 6B schematically depicts a cross-sectional side view of the support structure shown in FIG. 6A.

FIG. 6C schematically shows another cross-sectional side view of the support structure illustrated in FIG. 6A.

FIG. 6D schematically illustrates the support structure shown in FIG. 6A from a top perspective view.

FIG. 7A schematically shows a positioning device that includes the support structure of FIG. 2 from a top view.

FIG. 7B schematically illustrates the positioning device of FIG. 7A from a side elevational view.

FIG. 7C schematically illustrates the positioning device of FIG. 7A from another side elevational view.

FIG. 7D schematically illustrates the positioning device of FIG. 7A from a perspective view.

FIG. 7E schematically shows a perspective view of the positioning device of FIG. 7A mounted on a translational mechanism.

FIG. 8A schematically shows an alignment member of a positioning device from a detailed top view.

FIG. 8B schematically depicts the alignment member of FIG. 8A from a detailed side view.

FIG. 8C schematically shows the alignment member of FIG. 8A from a detailed bottom view.

FIG. 9A schematically shows an alignment member of a positioning device from a detailed top view.

FIG. 9B schematically depicts the alignment member of FIG. 9A from a detailed side view.

FIG. 9C schematically shows the alignment member of FIG. 9A from a detailed bottom view.

FIG. 10A schematically shows a pusher component from a detailed front view.

FIG. 10B schematically shows the pusher component of FIG. 10A from a detailed side view.

FIG. 10C schematically shows the pusher component of FIG. 10A from a detailed rear view.

FIG. 11A schematically shows a lever arm of a pusher from a detailed front view.

FIG. 11B schematically depicts the lever arm of FIG. 11A from a detailed rear view.

FIG. 11C schematically shows the lever arm of FIG. 11A from a detailed perspective view.

FIG. 12A schematically depicts a lever shaft of a pusher from a detailed front view.

FIG. 12B schematically illustrates the lever shaft of FIG. 12A from a detailed side view.

FIG. 12C schematically illustrates the lever shaft of FIG. 12A from a detailed top view.

FIG. 12D schematically shows the lever shaft of FIG. 12A from a detailed perspective view.

FIG. 13A schematically depicts a pin capture block of a pusher from a detailed top view.

FIG. 13B schematically shows the pin capture block of FIG. 13A from a detailed side view.

FIG. 13C schematically depicts the pin capture block of FIG. 13A from a detailed bottom view.

FIG. 14A schematically shows a positioning device from a perspective view according to one embodiment of the invention.

FIG. 14B schematically shows the positioning device of FIG. 14A from a partially exploded perspective view.

FIG. 14C schematically illustrates a partially transparent top view of a portion of a nest from the positioning device of FIG. 14A.

FIG. 14D schematically shows the nest of FIG. 14C from a bottom perspective view.

FIG. 14E schematically depicts a detailed perspective view of the rotational coupling components shown in FIG. 14D.

FIG. 15 schematically shows a perspective view of a container station according to one embodiment of the present invention.

FIG. 16 schematically depicts the container station of FIG. 15 from a top view.

FIG. 17A schematically shows a top view of a microtiter plate.

FIG. 17B schematically illustrates a bottom view of the microtiter plate shown in FIG. 17A.

FIG. 17C schematically depicts a cross-sectional view of the microtiter plate shown in FIG. 17A.

FIGS. 18A-D are diagrammatic representations of an x-axis pusher and a y-axis pusher positioning a microtiter plate.

FIG. 19 is a block diagram showing electrical, vacuum, and air interconnections in an container station of a positioning device according to one embodiment of the invention.

FIG. 20 schematically shows a partial cross-sectional view of a container station according to one embodiment of the invention.

FIG. 21 schematically shows a partial side elevational view a piston and lever mechanism for a pusher according to one embodiment of the present invention.

FIG. 22 schematically illustrates a perspective view of a pusher lever according to one embodiment of the invention.

FIG. 23 is a diagram showing part placement on the underside of a container station according to one embodiment of the invention.

FIG. 24 schematically shows an automated system from a perspective view according to one embodiment of the invention.

### DETAILED DISCUSSION OF THE INVENTION

The invention provides positioning devices for accurately and precisely positioning multi-well containers on support surfaces of container stations, and for retaining those containers in desired positions on the support surfaces, which containers are typically subjected to further processing. For example, the systems of the invention that include the positioning devices described herein support a broad range of assay formats, including screens for compounds with desired properties. The systems of the invention are typically highly automated with minimal user intervention for repeated usage at high throughput in, e.g., laboratory and industrial settings. The devices, systems, and methods described herein are also highly adaptable such that a variety of samples and sample assays can be accommodated to acquire information about the samples.

More specifically, the present invention provides positioning devices that include container stations that are structured to position essentially any multi-well container, including high density containers having over 1000 wells. The wells of multi-well containers positioned in the containers stations of the positioning devices described herein are typically accessible substantially simultaneously (e.g., along planes that are substantially perpendicular to top surfaces of the containers), e.g., to dispense and/or remove materials from the wells. In certain embodiments, for example, container stations are tiered relative to one another in a given positioning device such that containers positioned in different tiered stations are accessible by, e.g., robotic translocation devices without contacting one another. Container stations typically include alignment members for aligning multi-well containers in the stations. In some embodiments, container stations are rotationally coupled to support structures of positioning devices to adjust multi-well container positions. In other embodiments, tiered container stations having alignment members are also rotationally coupled to device support structures.

The invention further provides automated systems that include the positioning devices described herein. The systems of the invention include material handling devices for dispensing and/or removing materials from selected wells disposed in multi-well containers positioned in the positioning devices of the systems. The systems of the invention also typically include various additional components for performing many different types of chemical syntheses, compound screening, and other processes. In addition, the invention also provides methods of positioning multi-well containers in the devices of the invention for additional processing, including material transfer and assay detection.

While the present invention will be described with reference to a few specific embodiments, the description is illustrative of the invention and is not to be construed as limiting the invention. Various modifications to the present invention can be made to the preferred embodiments by those skilled in the art without departing from the true scope of the invention as defined by the appended claims. It is noted here that for a better understanding, like components are designated by like reference letters and/or numerals throughout the various figures, unless the context indicates otherwise.

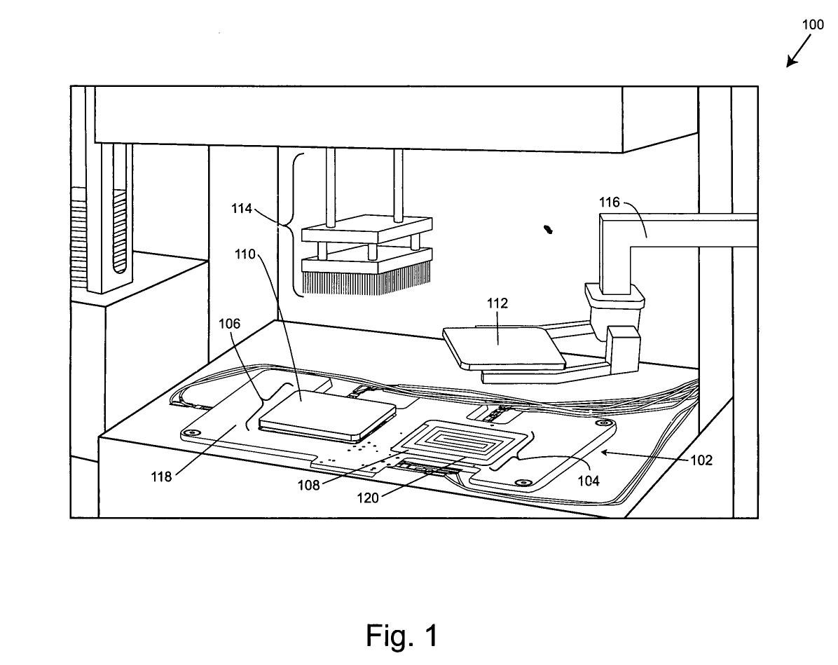

FIG. 1 schematically shows representative automated system 100 from a perspective view according to one embodiment of the invention. As shown, automated system 100 includes positioning device 102, which includes support structure 118. Support structure 118 includes container stations 104 and 106 that each include support surface 108 (one not within view) structured to position multi-well containers 110 and 112 relative to material handling device 114 (shown as a fluid transfer device), robotic translocation device 116, an electromagnetic energy source (not within view), and a detector (not within view). Optionally, container station 104 is utilized to position a multi-well plate containing sample compounds and container station 106 is utilized to position an assay multi-well plate into which compounds are transferred from the sample compound multi-well plate positioned in container station 104 using fluid transfer device 114. Robotic translocation device 116 is used to translocate multi-well plates to and/or from container stations 104 and 106. Each of these system components is described in greater detail below.

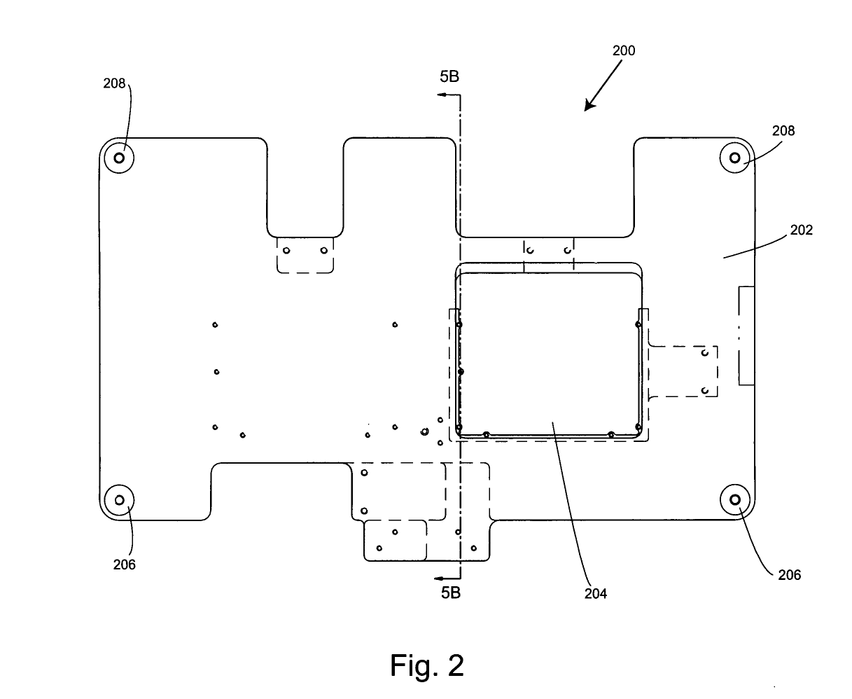

To further illustrate aspects of the present invention, FIG. 2 schematically depicts support structure 202 of positioning device 200 from a bottom view. As shown, support structure 202 includes cutout or orifice 204 disposed through positioning device 200 such that when an assay container is positioned over orifice 204, the container can receive electromagnetic energy or radiation from an electromagnetic source (e.g., via an optical system, etc.) and/or the detector can receive electromagnetic radiation from the container through orifice 204. Although other materials such as structural polymers, steel and other metals are optionally utilized, support structure 202 is typically fabricated from aluminum and finished with a black anodization.

Component Fabrication is Described Further Below.

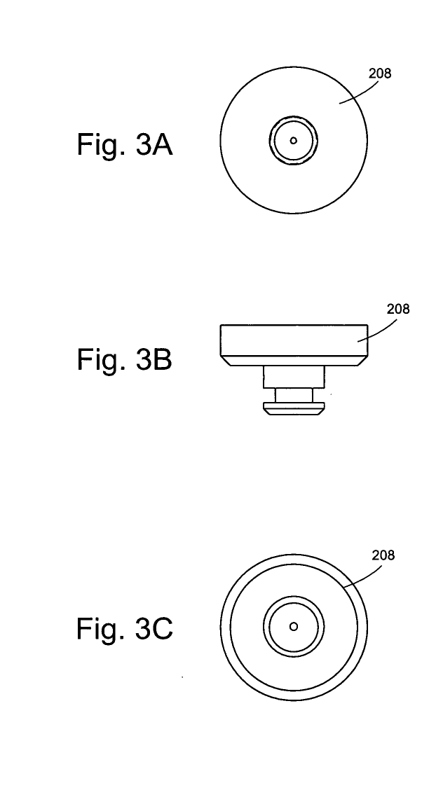

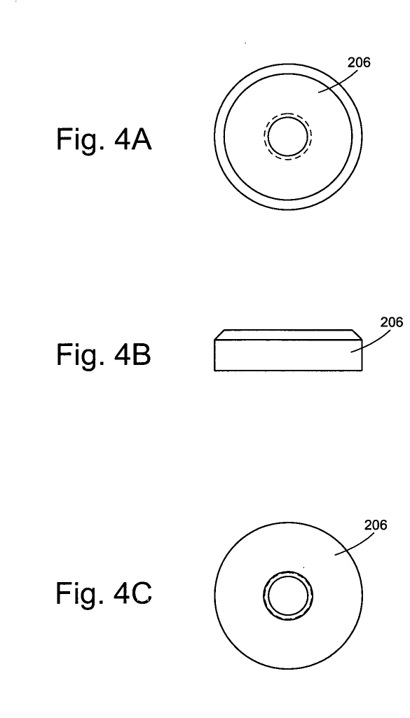

As also shown in FIG. 2, front feet 208 and rear feet 206 are typically attached to support structure 202 to position positioning device 200 relative to other system components of the invention. In certain embodiments, for example, another system component, such as a stage or platform will include corresponding indentations that are configured to receive front feet 208 and rear feet 206 when positioning device 200 is positioned in the system. FIGS. 3 and 4 schematically depict front feet 208 and rear feet 206, respectively, from various detailed views. In particular, FIGS. 3A-C schematically show front foot 208 from detailed bottom, side, and top views, respectively. FIGS. 4A-C schematically depict rear foot 206 from detailed top, side, and bottom views, respectively. While other materials are optionally utilized, front feet 208 and rear feet 206 are typically fabricated from aluminum and optionally finished with a black anodization.

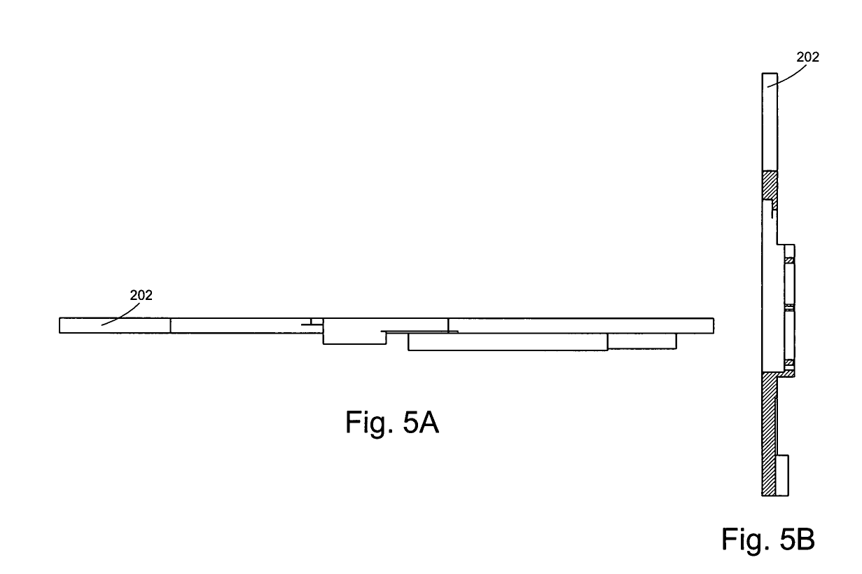

FIG. 5A schematically shows a side view of support structure 202 shown in FIG. 2. To further illustrate the positioning devices of the invention, FIG. 5B schematically illustrates a cross-sectional side view along section 5B of support structure 202 depicted in FIG. 2.

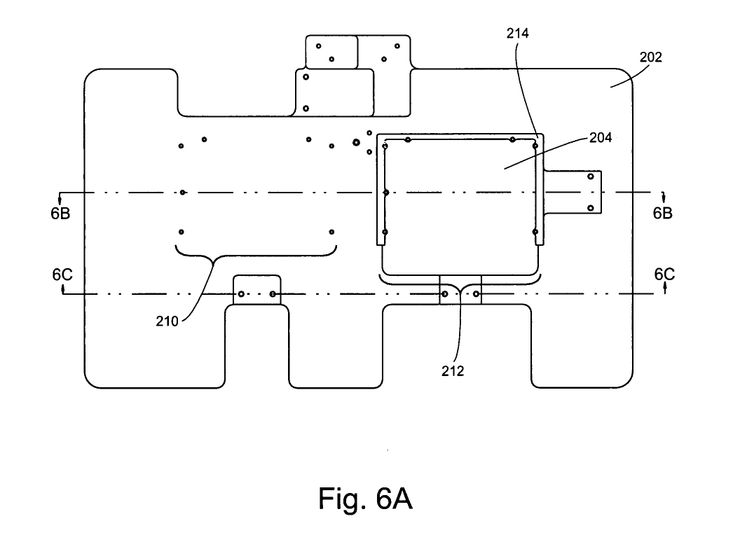

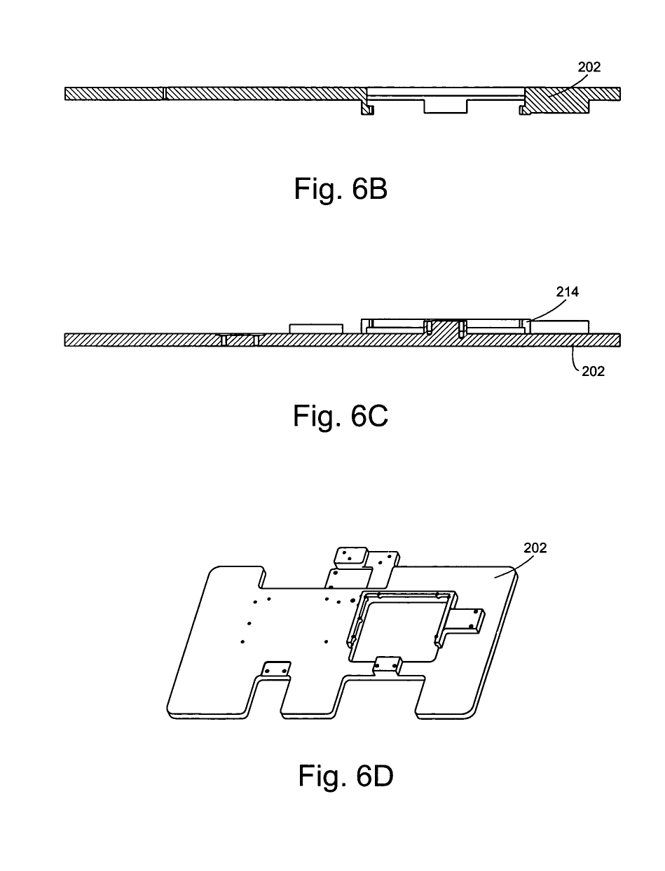

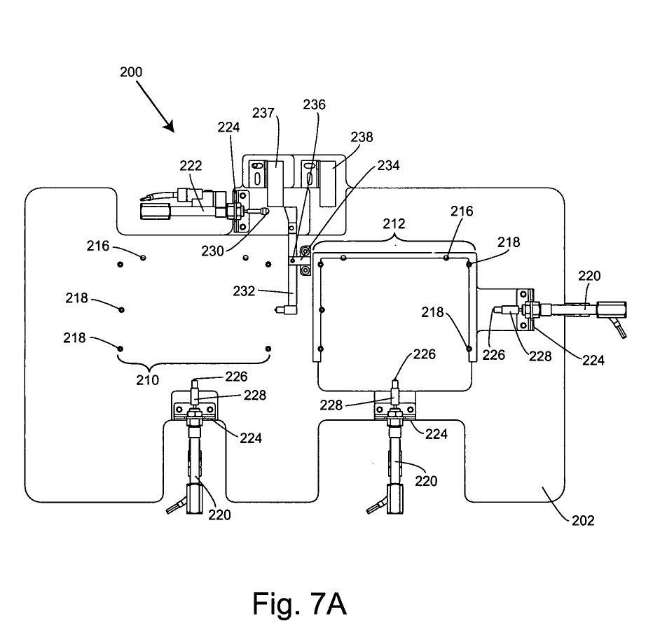

The positioning devices of the invention generally include multiple container stations, e.g., to position multiple containers for material transfer when performing a given assay. In preferred embodiments, at least two of the container stations are tiered, that is, disposed at different levels. In systems that include robotic translation devices, tiered container stations have the advantage of allowing the robotic device to access and handle (e.g., grasp and re-locate) a first container positioned at one tiered container station without contacting a second container positioned at another tiered container station, e.g., at least along planes that are substantially parallel to top surfaces (i.e., surfaces in which wells are disposed) of the containers. This is further illustrated in, e.g., FIGS. 6A-D. In particular, FIG. 6A schematically shows support structure 202 shown in FIG. 2 from a top view. As shown, support structure 202 includes container station 210 and container station 212. Container station 212 includes orifice 204 disposed through support structure 202, as described above. In addition, container station 212 further includes tier structure 214 disposed around a portion of orifice 204. Tier structure 214 positions (i.e., provides a support surface for) containers at a different level in container station 212 than those positioned in container station 210. FIGS. 6B and C schematically depict cross-sectional side views of support structure 202 shown in FIG. 6A along sections 6B and 6C, respectively. To further illustrate, FIG. 6D schematically illustrates support structure 202 from a top perspective view. In addition, the container stations of the invention are typically configured such that the wells of multi-well containers positioned in two or more of the container stations are accessible (e.g., along an axis that is substantially perpendicular to top surfaces of the containers) substantially simultaneously (e.g., using a fluid handling device or the like).

The container stations of the positioning devices of the invention also optionally include heating elements (e.g., external to or integral with the container stations) to regulate temperature in the container, e.g., when an assay is performed in the system. Suitable heating elements that can be adapted for use in the systems of the invention are generally known in the art and are readily available from various commercial sources. Heating elements are typically operably connected to a power source and/or system controllers, which control operation of the elements. An exemplary heating element is schematically illustrated in FIG. 1, which shows heating element 120 disposed on support surface 108 of container station 104.

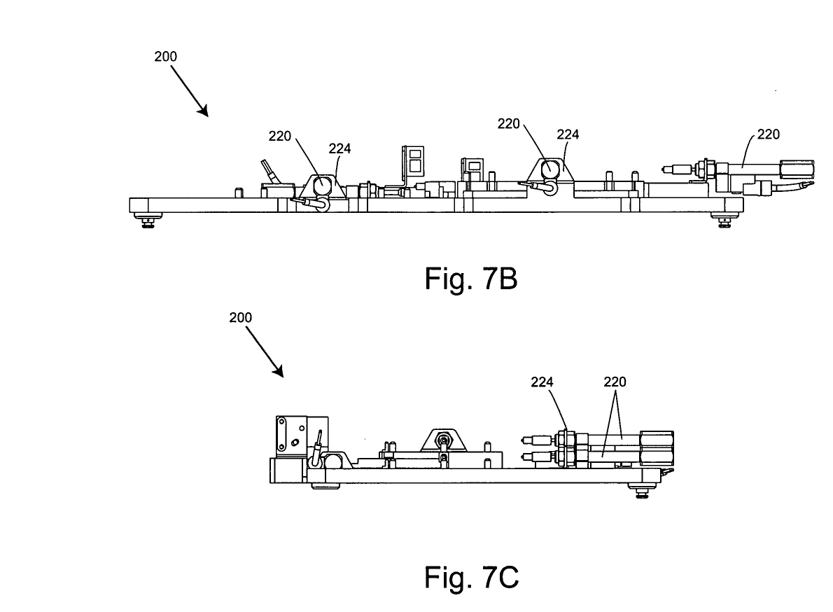

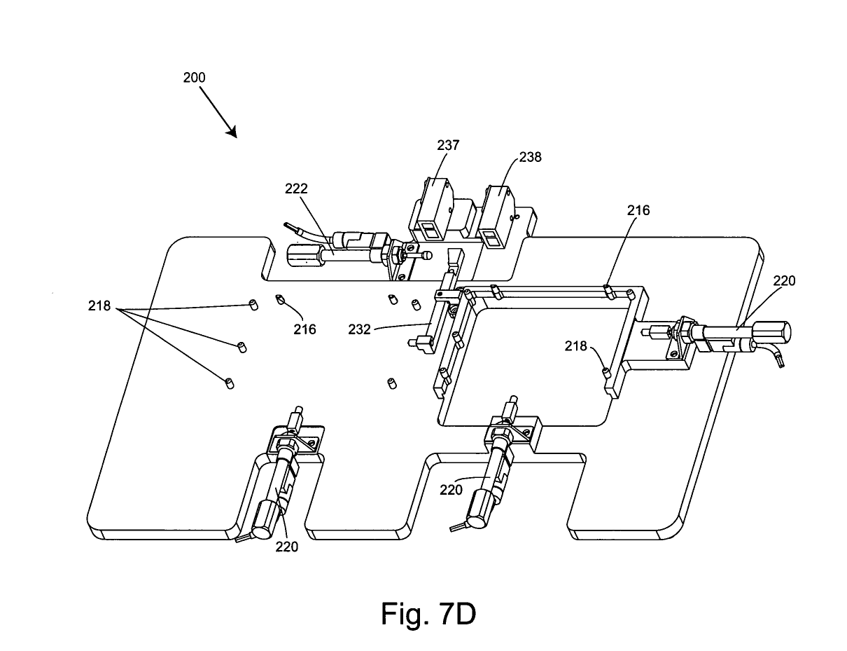

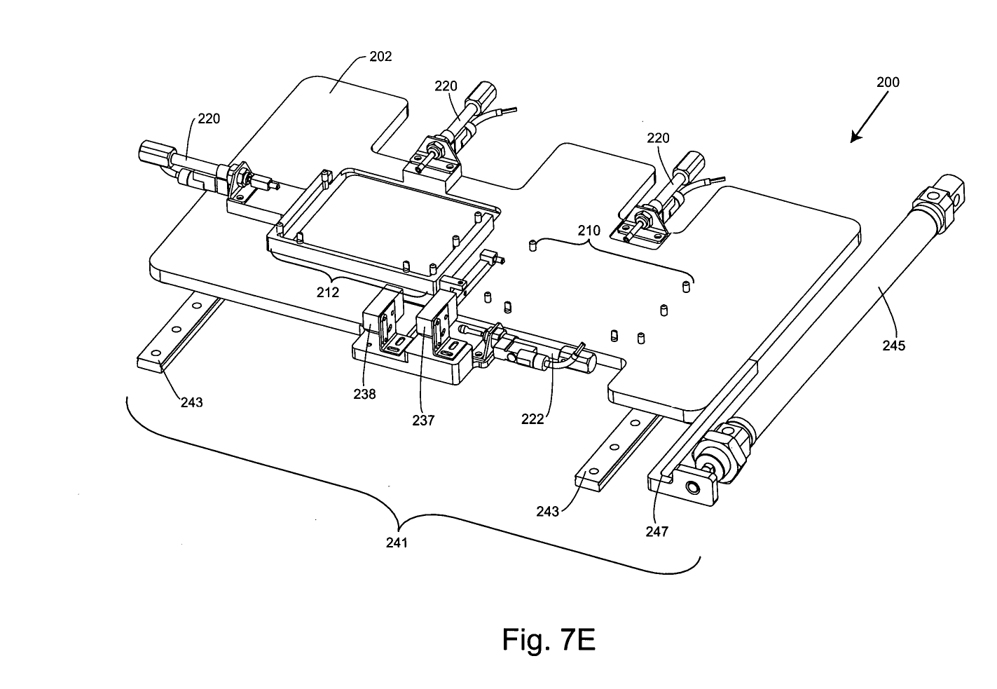

The positioning devices of the invention generally include alignment members that are positioned to contact surfaces of containers (e.g., inner walls of alignment receiving areas, etc.) when the containers are positioned in the container stations such that the containers align with the material handling devices and/or other system components. Alignment receiving areas of multi-well containers are described in greater detail below. In addition, these positioning devices also typically include pushers that push the containers into contact with the alignment members when the containers are positioned in the container stations. Embodiments of these aspects of the positioning devices of the invention are illustrated in FIGS. 7A-E. More specifically, FIG. 7A schematically shows positioning device 200 from a top view. As shown, positioning device 200 includes alignment members 216 (shown as trimmed face locating pins) and alignment members 218 (shown as locating pins having curved surfaces), which align with inner surfaces of standard multi-well plates positioned in container stations 210 and 212. When more than two alignment members are included substantially along the same line, such as alignment members 218 of container station 210, at least one of those members is typically slightly offset from the others in the line as only three points of contact will determine the position of a container (e.g., two alignment members 218 and one alignment member 216). As also shown, positioning device 200 further includes pneumatically-driven pushers 220 and 222 (e.g., air cylinders or the like), which effect container positioning relative to alignment members 216 and 218. Pushers 220 and 222 are mounted to support structure 202 via pusher mounts 224 and are operably connected to pressure sources (not shown). Pushers 220 include spring plungers 226 and plunger posts 228. Pusher 222 includes knob 230 that contacts lever arm 232 to push lever arm 232 into contact with a container. Lever arm 232 is mounted to support structure 202 via pin capture block 234 and lever shaft 236, which form a pivotal coupling. As also shown in FIG. 7A, container positioning device 200 also includes position sensors or laser assemblies 237 and 238 for detecting the presence of containers in container stations 210 and 212, respectively. FIGS. 7B and C schematically show positioning device 200 from side elevational views. In addition, FIG. 7D schematically illustrates positioning device 200 from a perspective view.

To further illustrate aspects of the invention, FIG. 7E schematically shows a perspective view of positioning device 200 of FIG. 7A mounted on translational mechanism 241. When positioning devices are included in systems such as automated system 100 schematically shown in FIG. 1, translational mechanisms are optionally included such that positioning devices can be translocated along at least one translational axis, e.g., to facilitate access to multi-well containers positioned in the positioning devices by a user, a robotic translocation device, and/or the like. In the embodiment shown, translational mechanism 241 includes rails or tracks 243 on which positioning device 200 is mounted and along which positioning device 200 slides. In addition, actuator 245 (e.g., an air cylinder, motor, etc.) is operably connected to support structure 202 of positioning device 200 via bracket 247. Actuator 245, which is generally operably connected to a controller, effects translocation of positioning device 200 along tracks 243.

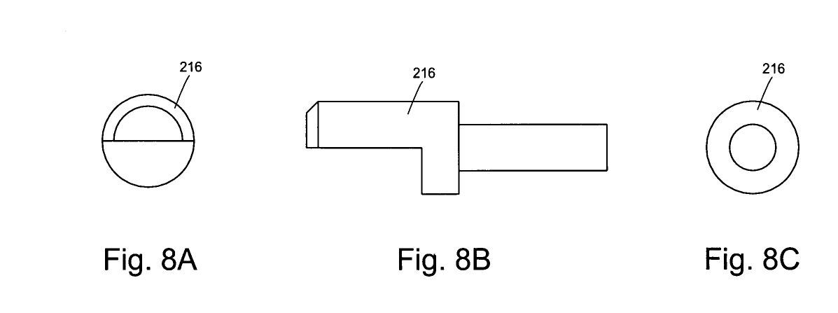

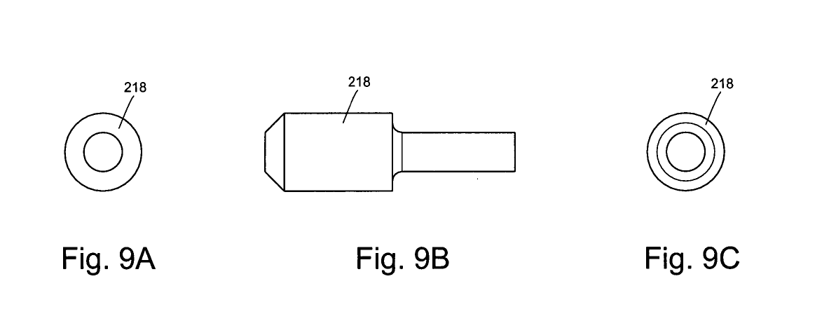

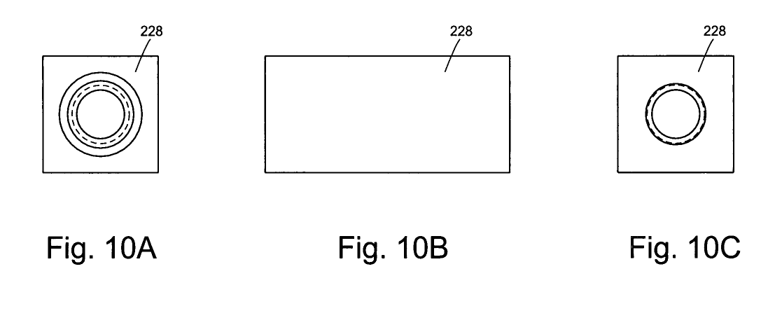

FIG. 8A schematically shows alignment member 216 of positioning device 200 from a detailed top view, while FIGS. 8B and C schematically show alignment member 216 from detailed side and bottom views, respectively. Further, FIG. 9A schematically shows alignment member 218 of container positioning device 200 from a detailed top view, whereas FIGS. 9B and C schematically depict alignment member 218 from detailed side and bottom views, respectively. Additionally, FIGS. 10A-C schematically show plunger post 228 from detailed front, side, and rear views, respectively. Although other materials are optionally used, these components are typically fabricated from aluminum and optionally finished with a black anodization.

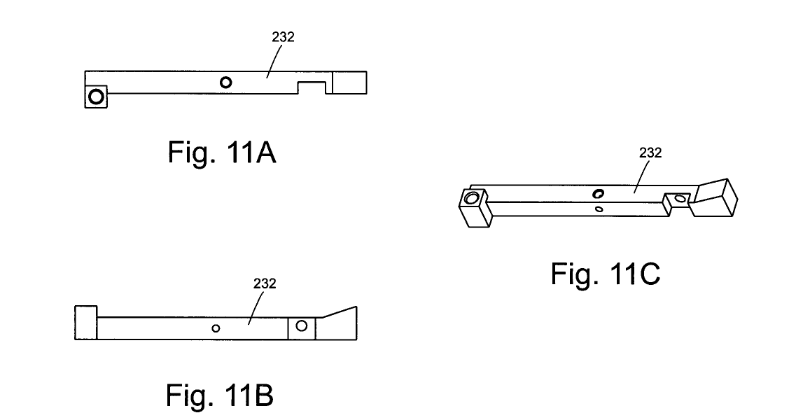

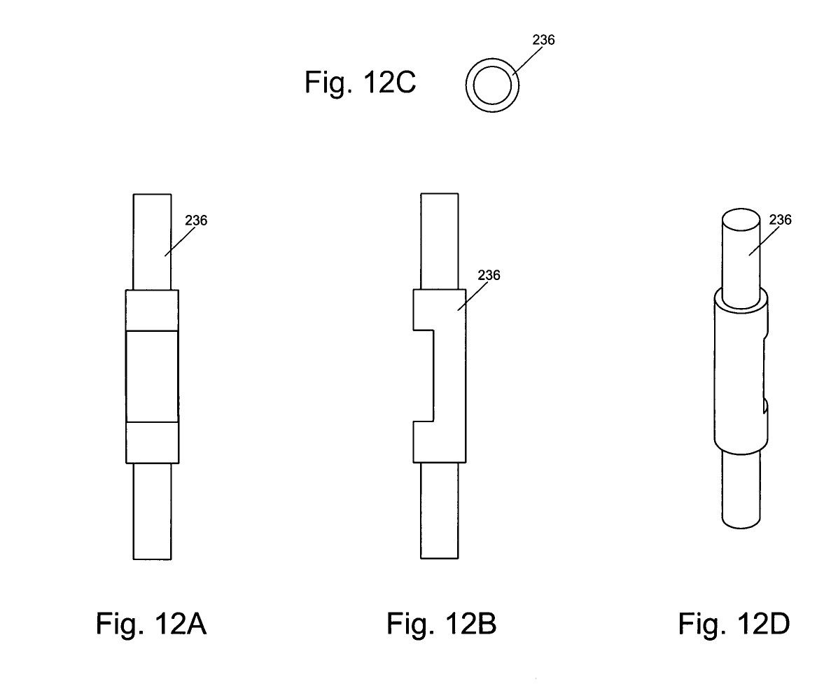

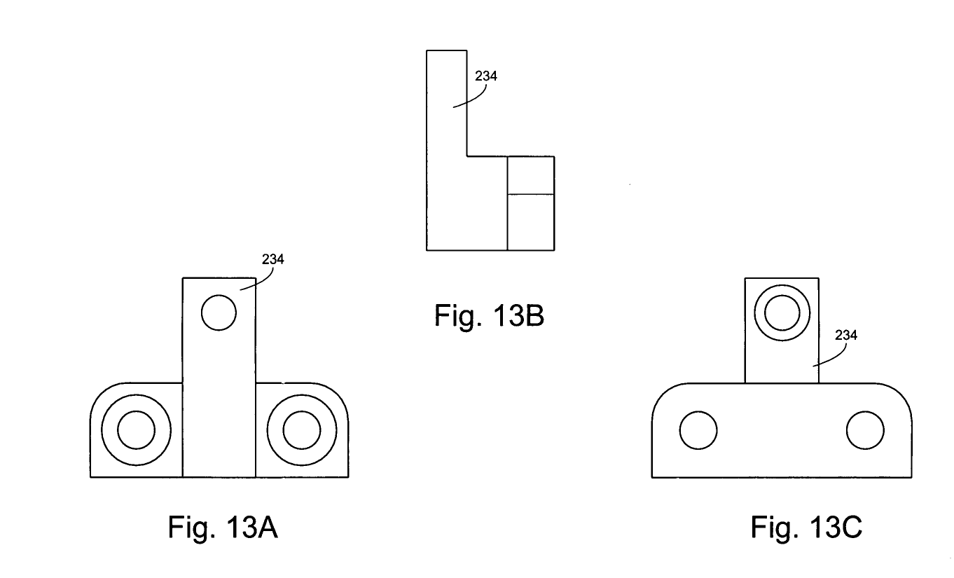

FIGS. 11-13 schematically show detailed views of various pusher components related to pusher 222. In particular, FIGS. 11A-C schematically show lever arm 232 from detailed front, rear, and perspective views, respectively. FIGS. 12A-D schematically depict lever shaft 236 from detailed front, side, top, and perspective views, respectively. In addition, FIGS. 13A-C schematically show pin capture block 234 from detailed top, side, and bottom views, respectively. As with other components of the container positioning devices of the invention, while other materials are optionally utilized, these components are also typically fabricated from aluminum and optionally finished with a black anodization.

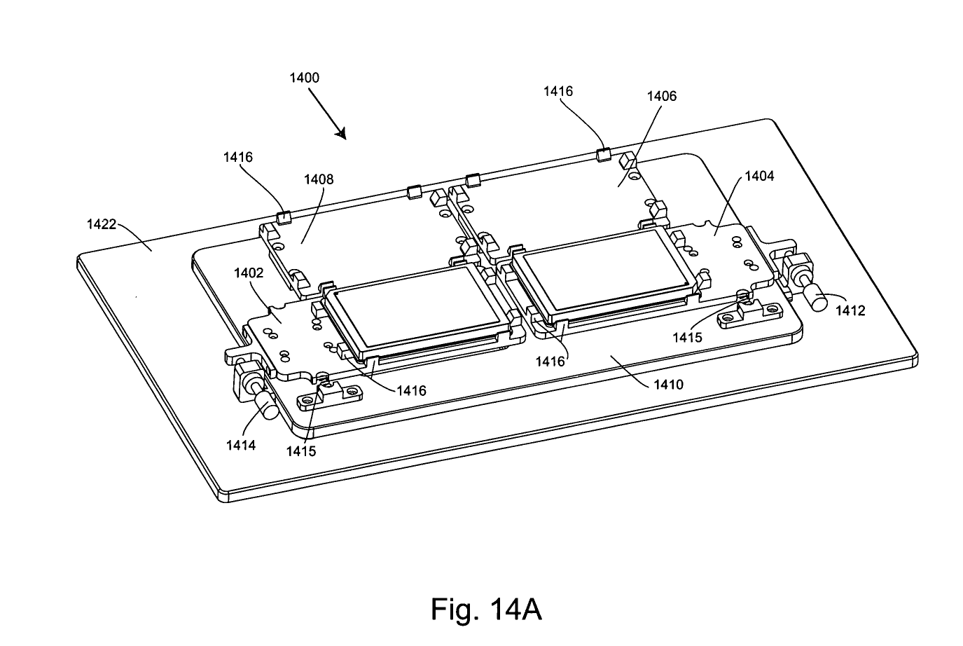

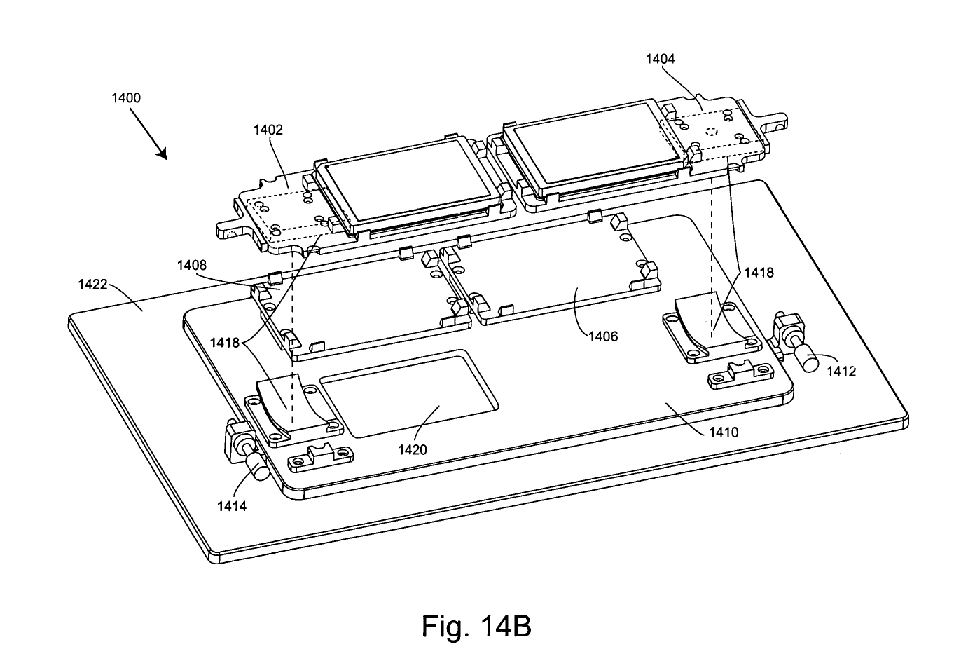

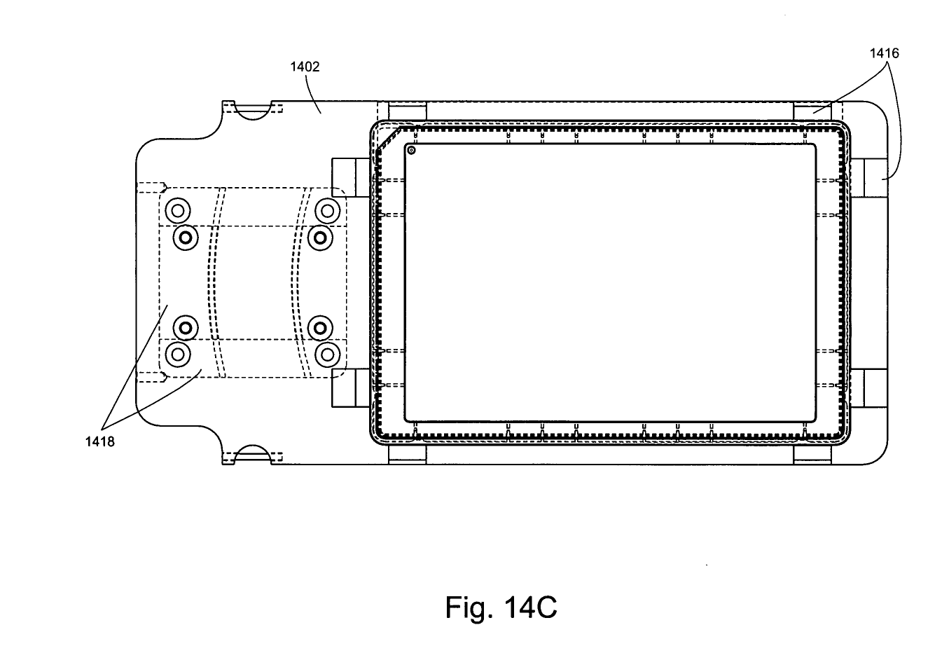

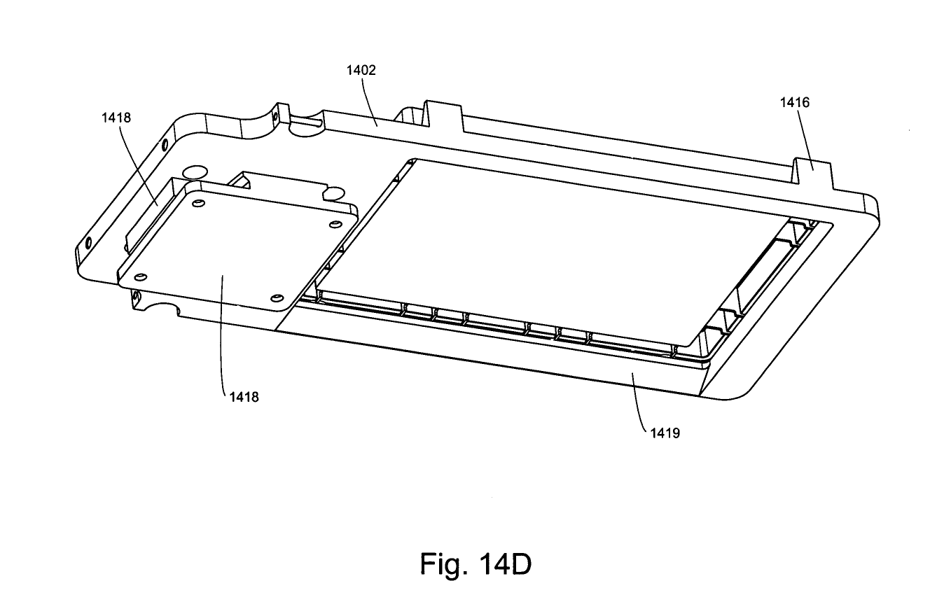

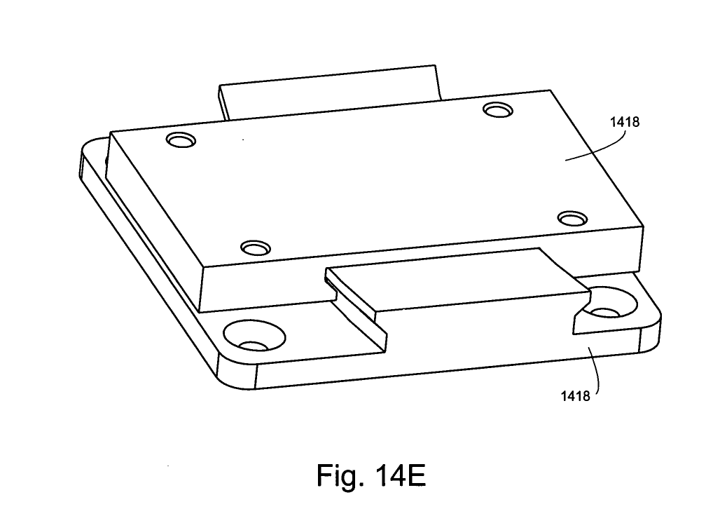

The container positioning devices of the present invention also include other embodiments. For example, FIG. 14A schematically shows positioning device 1400 from a perspective view. As shown, container positioning device 1400 includes nests 1402, 1404, 1406, and 1408 in which multi-well containers can be placed to position the containers relative to other system components. Nests 1402, 1404, 1406, and 1408 are typically precisely fabricated (e.g., machined, molded, etc.) such that sample plates fit tightly (i.e., substantially without room for lateral movement, etc.) into nests 1402, 1404, 1406, and 1408. Component fabrication is described further below. As shown, nests 1402, 1404, 1406, and 1408 each include multiple alignment members 1416 that include angled surfaces that are configured to direct multi-well containers into nests 1402, 1404, 1406, and 1408, respectively, when such containers are placed into those nests. Nests 1402 and 1404 are fabricated to rotate, e.g., about the centers of plates positioned in those nests so that plate positions can be adjusted to align with, e.g., material handling devices, robotic translocation devices, and the like. This eliminates the need to include a corresponding rotational adjustment in these other system components. However, in some embodiments, these other rotational adjustments are also included for additional control over the alignment of the various system components.

FIG. 14B schematically shows positioning device 1400 of FIG. 14A from a partially exploded perspective view. As shown, nest 1402 and 1404 rotate about rotational coupling components 1418 (shown as a carriage and base that mate via a dovetail joint) that mate with or otherwise contact both the particular nest and top tier support structure component 1410 of positioning device 1400, which are typically disposed proximal to an end of the particular nest. Rotational coupling components 1418 are typically fabricated from stainless steel with a thin (e.g., 0.002 inches thick) brass, TEFLON™, or other shim inserted between the two pieces to provide a bearing surface. Other rotational couplings, which are generally known in the art, are also optionally utilized. The rotational positions of nests 1402 and 1404 are individually adjusted using set screws 1414 and 1412, respectively, or other functionally equivalent rotational adjustment features. Springs 1415 provide counteracting tension to set screws 1414 and 1412 to maintain the selected rotational position of nests 1402 and 1404. In addition, nest 1402 includes orifice or cutout 1420 so that when a container is positioned over the orifice 1420, the container can receive electromagnetic radiation from an electromagnetic source and/or the detector can receive electromagnetic radiation from the container through orifice (e.g., via an optical system, etc.). Additional details relating to the container positioning devices of the present invention are described in, e.g., International Publication No. WO 01/96880, entitled “AUTOMATED PRECISION OBJECT HOLDER,” filed Jun. 15, 2001 by Mainquist et al., which is incorporated by reference in its entirety.

To further illustrate the invention, FIG. 14C schematically shows a partially transparent top view of a portion of nest 1402 of positioning device 1400. The relative orientation of rotational coupling components 1418 is shown. This is further depicted in FIG. 14D, which schematically shows nest 1402 from a bottom perspective view. As shown, edge 1419 includes an angled cut surface (e.g., at approximately 45°) to allow, e.g., electromagnetic radiation from an excitation laser or other electromagnetic radiation source to be incident on any selected well of a given multi-well container without being obstructed the nest structure. These angled edges are also typically included in other container stations having orifices as described herein. In addition, FIG. 14E schematically depicts a detailed perspective view of rotational coupling components 1418.

Nests 1406 and 1408 are optionally used to position additional sample plates. In some embodiments, at least one of nests 1406 and 1408 is used as a fluid handling device blotting station to remove adherent fluid from fluid handling device components (e.g., a pipettor, a pin tool, etc.) before or after a fluid handling step is performed. In these embodiments, blotting paper (not shown) is placed in, e.g., nest 1406 and a pin tool is contacted with the paper such that adherent fluid is blotted, wicked, or otherwise removed from the pins of pin tool. In certain embodiments, the systems of the invention include a vacuum drying station that removes adherent fluid from fluid handling device components under an applied vacuum when those components are disposed proximal to the vacuum drying station. Optionally, such a vacuum drying station replaces, e.g., nest 1406 and/or nest 1408 or is positioned at another location that is either internal or external to a system of the invention. Although not shown in FIG. 14, positioning device 1400 also optionally includes material handling device washing stations, which typically include wash reservoirs (e.g., recirculation troughs or baths, etc.) disposed, e.g., on an expanded bottom tier support structure component 1422 of container positioning device 1400 or at another position in a system of the invention. Blotting stations, vacuum drying stations, washing stations, and other aspects of the present invention are further described in, e.g., Attorney Docket No. 36-002900US, entitled “NON-PRESSURE BASED FLUID TRANSFER IN ASSAY DETECTION SYSTEMS AND RELATED METHODS,” filed Aug. 4, 2003 by Evans et al., which is incorporated by reference in its entirety.

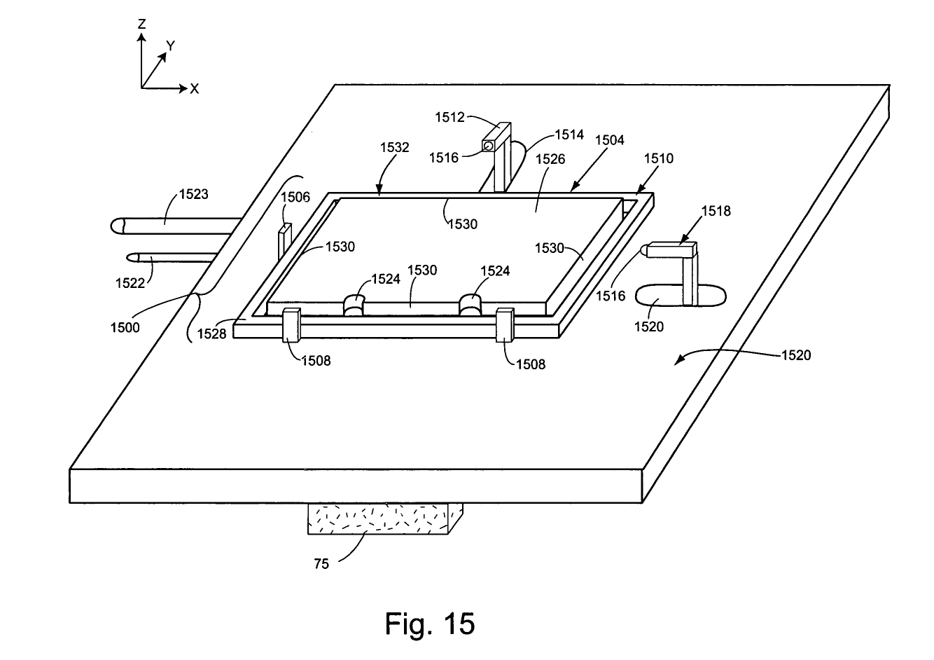

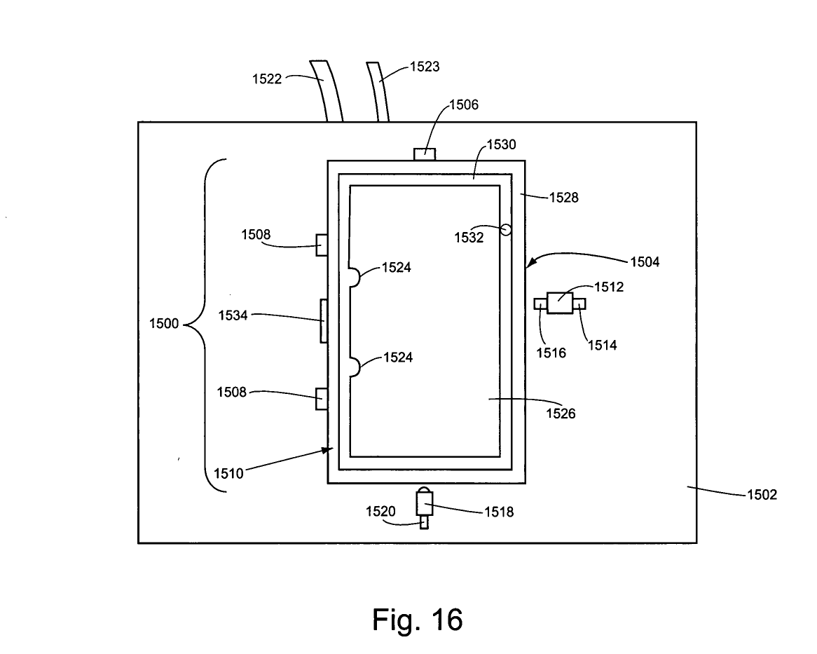

For positioning along two different axes, the positioning devices of the invention generally have one or more alignment members positioned to receive each of the two axes of the multi-well container. For example, FIGS. 15 and 16 show one embodiment of container station 1500 in accordance with the present invention. As shown, container station 1500 is disposed on support structure 1502 of a positioning device (only a portion is shown). Support structure 1502 supports vacuum plate 1504. Protrusions 1506 and 1508 function as alignment members. The illustrated embodiment of the container station 1500 has two y-axis protrusions 1508 and one x-axis protrusion 1506 extending from support structure 1502. Accordingly, y-axis protrusions 1508 and x-axis protrusion 1506 are fixedly positioned relative to the vacuum plate 1504, which, in this embodiment, acts to hold the multi-well container in position once it has been positioned. Y-axis locating protrusions 1508 are constructed to cooperate with a y-axis surface of an multi-well container (e.g., an y-axis wall of a microtiter plate), while x-axis protrusion 1506 is constructed to cooperate with an x-axis surface of the container (e.g., an x-axis wall of a microtiter plate).

The alignment members can be, for example, locating pins, tabs, ridges, recesses, or a wall surface, and the like. In preferred embodiments, an alignment member includes a curved surface that contacts a properly positioned multi-well container. The use of a curved surface minimizes the effect of, for example, roughness of the container surface that contacts the alignment member. The use of two alignment members along one axis and one alignment member along the second axis, as shown in FIGS. 15 and 16, is another approach to minimize the effect of surface irregularities on the proper positioning of the container. The multi-well container contacts three points along the surface of the container, so proper alignment is not dependent upon the entire container surface being regular.

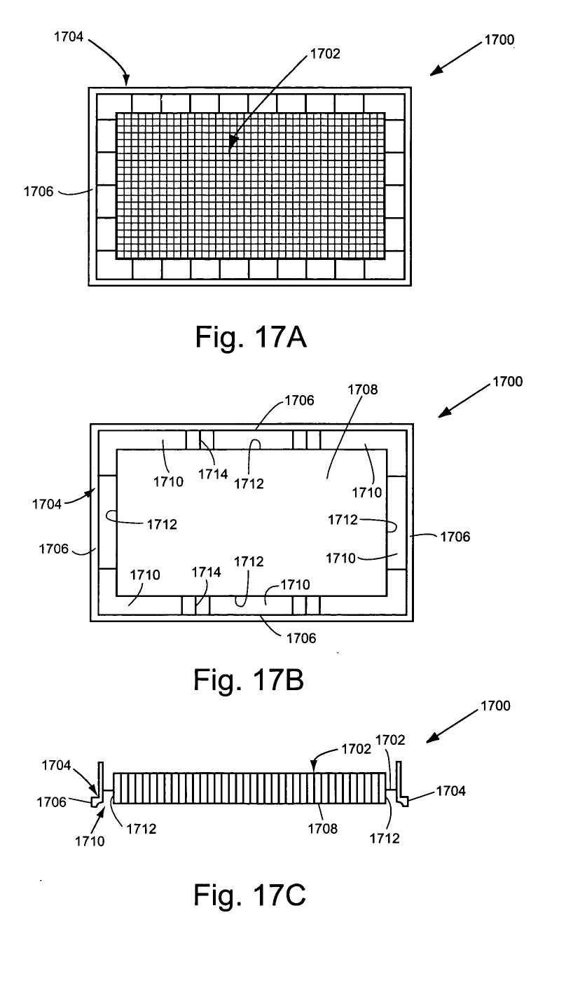

Another aspect of the invention applies specifically to positioning of microtiter plates. To illustrate, microtiter plate 1700 is shown in FIGS. 17A-C. As shown, microtiter plate 1700 comprises well area 1702 which has many individual sample wells for holding samples and reagents. Microtiter plates are available in a wide variety of sample well configurations, including commonly available plates with 6, 12, 24, 48, 96, 192, 384, 768, 1536, or more wells. It will be appreciated that microtiter plates are available from a variety of manufacturers including, e.g., Greiner America Corp. (Lake Mary, Fla.). Microtiter plate 1700 has outer wall 1704 having registration edge 1706 at its bottom. In addition, microtiter plate 1700 includes bottom surface 1708 below the well area on the plate's bottom side. Bottom surface 1708 is separated from the outer wall 1704 by alignment member receiving area 1710. Alignment member receiving area 1710 is bounded by a surface of outer wall 1704 and by inner wall 1712 at the edge of bottom surface 1708. Although there may be some lateral supports 1714 in alignment member receiving area 1710, these areas are generally open between inner wall 1712 and an inner surface of the outer wall 1704.

According to the invention, to position a microtiter plate the alignment members of the container station are optionally arranged to cooperate with inner wall 1712 of the microtiter plate. Inner wall 1712 is advantageously used, as inner wall 1712 is typically more accurately formed and is more closely associated with the perimeter of the sample well area, as compared to an outer wall of the plate 1700, such as wall 1704. Accordingly, aligning an inner wall (e.g., inner wall 1712) of a microtiter plate relative to alignment members is generally preferred to aligning with an outer wall, such as wall 1704. The increased positioning precision that is obtained by using an inner wall as the alignment surface makes possible the use of high-density microtiter plates, such as 1536 well plates. Further, by having the alignment members (e.g., alignment protrusions 1506 and 1508) cooperate with an inner wall 1712 of plate 1700, minimal structures are needed adjacent the outside of the plate. In such a manner, a robotic arm or other transport device is able to readily access plate 1700. Having the protrusions positioned adjacent inner wall 1712 thereby facilitates translocating plate 1700. However, it will be appreciated that the alignment members or protrusions can be placed in alternative positions and still facilitate the precise positioning of the plate.

The positioning devices of the invention generally include one or more movable members. The movable members function to move a container against one or more alignment members. For example, once a multi-well container is placed in the general location of the alignment member(s), the movable members (termed “pushers” herein) move the container so that an alignment surface of the container is in contact with one or more of the alignment members of the positioning device. The positioning device can have pushers for positioning of the container along one or more axes. For example, a positioning device will often have one or more pushers that position a container along an x-axis, and one or more additional pushers that position the container along a y-axis. The pushers can be moved by means known to those of skill in the art. For example, air cylinders, springs, pistons, elastic members, electromagnets or other magnets, gear drives, and the like, or combinations thereof, are suitable for moving the pushers so as to move containers into a desired position.

One embodiment of a container station of a positioning device having pushers for positioning a microtiter plate along both the x-axis and the y-axis is shown in FIGS. 15 and 16. When the microtiter plate is generally positioned adjacent the x- and y-axis protrusions, the bottom surface of the microtiter plate is directly above top surface 1510 of vacuum plate 1504. Y-axis pusher 1512, which extends through slot 1514 in support structure 1502, is used to apply pressure to a y-axis side wall of the microtiter plate. Sufficient force is applied to the plate at the plate contact 1516 to push the microtiter plate against y-axis protrusions 1508. When the microtiter plate is pushed against y-axis protrusions 1508, x-axis pusher 1518, which extends through slot 1520 of support structure 1502, is used to push an x-axis wall of the microtiter plate towards x-axis protrusion 1506. In this manner, the microtiter plate is accurately and precisely positioned relative both the x-axis and y-axis protrusions. It is sometimes advantageous, although not necessary, to have one or more of the pushers contact an inner wall of a microtiter plate rather than an outer wall. With this arrangement, the alignment members and pushers are underneath the microtiter plate. This leaves the area surrounding the exterior of the plate free of protrusions that could otherwise interfere with other devices that, for example, place the microtiter plate on the support.

As referred to above, the positioning device embodiment shown in FIGS. 15 and 16 includes vacuum plate 1504 that functions as a retaining device to hold a properly positioned container in a desired position. With both y-axis pusher 1512 and x-axis pusher 1518 applying sufficient force to precisely place the microtiter plate, a vacuum source (not shown) applies a vacuum through vacuum line 1522 into vacuum openings or holes 1524. Air source (not shown) applies air pressure through air line 1523 to effect movement of the pushers.

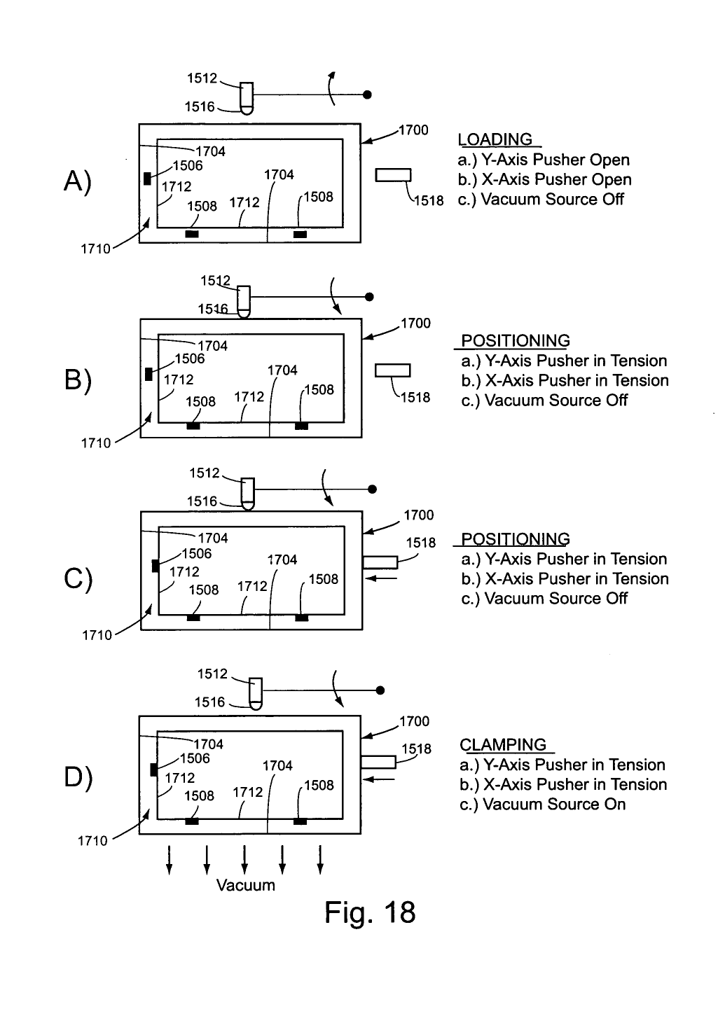

Referring now to FIGS. 18A-D, one embodiment of a general progression of positioning a container in container station 1500 is described. It is recognized that the positioning device can employ approaches that are equivalent to those illustrated to move a container into a desired position on the surface. Similarly, although the figures demonstrate the positioning of a microtiter plate in particular, one can readily adapt the arrangement of the positioning device components to position objects other than microtiter plates. In particular, FIGS. 18A-D show simplified bottom views of microtiter plate 1700 resting on the vacuum plate (not shown). FIG. 18A shows a loading position where microtiter plate 1700 is generally positioned relative x-axis and y-axis protrusions 1506 and 1508. When generally positioned, microtiter plate 1700 is positioned such that y-axis protrusions 1508 are received into alignment member receiving area 1710 along the y-axis edge of the microtiter plate and x-axis protrusion 1506 is received into alignment member receiving area 1710 along the x-axis edge of the microtiter plate. Accordingly, in this embodiment the protrusions are positioned in alignment member receiving area 1710 between inner wall 1712 and outer wall 1704. It will be appreciated that the protrusions may cooperate with the microtiter plate in alternative configurations to place the microtiter plate in a generally positioned orientation. Further, to facilitate loading, both y-axis pusher 1512 and x-axis pusher 1518 are positioned away from microtiter plate 1700.

Referring now to FIG. 18B, y-axis pusher 1512 is moved so as to contact an outer y-axis edge of microtiter plate 1700. As described above, the pusher could also be arranged to contact an inner well surface of the microtiter plate. Y-axis pusher 1512 is moved with sufficient force to force plate 1700 contact 1516 against wall 1704 of microtiter plate 1700. As y-axis pusher 1512 is pressed against microtiter plate 1700, the microtiter plate is moved, if necessary, to position inner wall 1712 against y-axis protrusions 1508. As y-axis pusher 1512 generally contacts the y-axis edge of the microtiter plate in a central location, the microtiter plate is moved with a minimum skewing force. In this manner, microtiter plate 1700 is firmly and reliably positioned in the y-axis.

With microtiter plate 1700 positioned in the y-axis, FIG. 18C shows that x-axis pusher 1518 is moved against an x-axis wall of microtiter plate 1700. In such a manner, x-axis pusher 1518 moves microtiter plate 1700 to position inner wall 1712 against x-axis protrusion 1506. While x-axis pusher 1518 is moving and holding plate 1700 against x-axis alignment member 1506, y-axis pusher 1512 remains pressed against the y-axis wall of microtiter plate 1700. To facilitate microtiter plate 1700 moving in the x-direction relative contact 1516, contact 1516 is preferably constructed to be a low friction element. For example, low friction contact point 1516 can be mounted on a spring-loaded member, which can keep a constant force against microtiter plate 1700 while permitting microtiter plate 1700 to be moved in the x-axis by x-axis pusher 1518. FIG. 21 shows an example of a suitable spring-loaded member. The contact point can also be coated with a low-friction material, such as TEFLON™, and the like. A low friction contact point can also be constructed by using a roller or rolling contact point, for example, or other means to reduce friction. A DELRIN™ ball plunger is another example of a suitable low friction contact point.

As shown in FIG. 18D, when microtiter plate 1700 has been moved into position by x-axis pusher 1518, microtiter plate 1700 is precisely positioned for further processing. With plate 1700 precisely positioned, a vacuum source (not shown) is activated, thereby securely drawing microtiter plate 1700 against a vacuum plate. Accordingly, microtiter plate 1700 is securely retained in its precise position, thereby allowing accurate and reliable further processing.

The invention also provides retaining devices for retaining microtiter plates in a desired position in the container stations. The retaining devices of the invention typically include a vacuum plate upon which the plate is placed. The vacuum plate generally has a top surface upon which the container to be retained is placed. One or more openings are present through which air can be withdrawn from the space between the top surface of the vacuum plate and the bottom surface of the container. The opening or openings can be connected to a vacuum source. When the container is properly positioned in a container station and a vacuum is applied, an airtight seal is formed between the container and the vacuum plate, thus holding the container in the desired position. For example, if the container is a microtiter plate, the bottom surface of the microtiter plate forms a seal with the top surface of the vacuum plate.

An example of a retaining device which can be included in the container stations of the invention is shown in FIGS. 15, 16 and 20. In this embodiment, the vacuum plate 1504 has top surface 1510 which generally comprises a central interior area 1526 and lip area 1528 which are separated by vacuum groove 1530. When the plate is generally positioned in the desired position, a bottom surface of the plate rests on lip area 1526 of top surface 1510. A vacuum source (not shown) applies a vacuum through vacuum line 1522 into vacuum openings or holes 1524. Openings 1524 are in communication with a vacuum groove 1530 which generally is positioned inside the perimeter of the vacuum plate 1504. In this manner, the vacuum effect is transferred around the entire perimeter of the plate. As the vacuum effect draws the bottom surface of the plate towards top surface 1510 of vacuum plate 1504, the container is retained by the vacuum force to vacuum lip 1528 and interior vacuum plate 1526.

In the example illustrated in FIGS. 15, 16 and 20, retaining device 1504 is provided as a rectangular vacuum plate, with a y-axis length constructed longer than an x-axis length. This particular vacuum plate 1504 is sized and constructed to cooperate with a bottom surface of a microtiter plate to retain the microtiter plate securely against top surface 1510 of vacuum plate 1504 when a vacuum source is activated. The vacuum plate also can be configured to retain objects other than microtiter plates. For example, the vacuum plate can be shaped to form a suction with essentially any flat surface of an object. A rectangular slot, for example, can be used to retain an object having a flat rectangular surface.

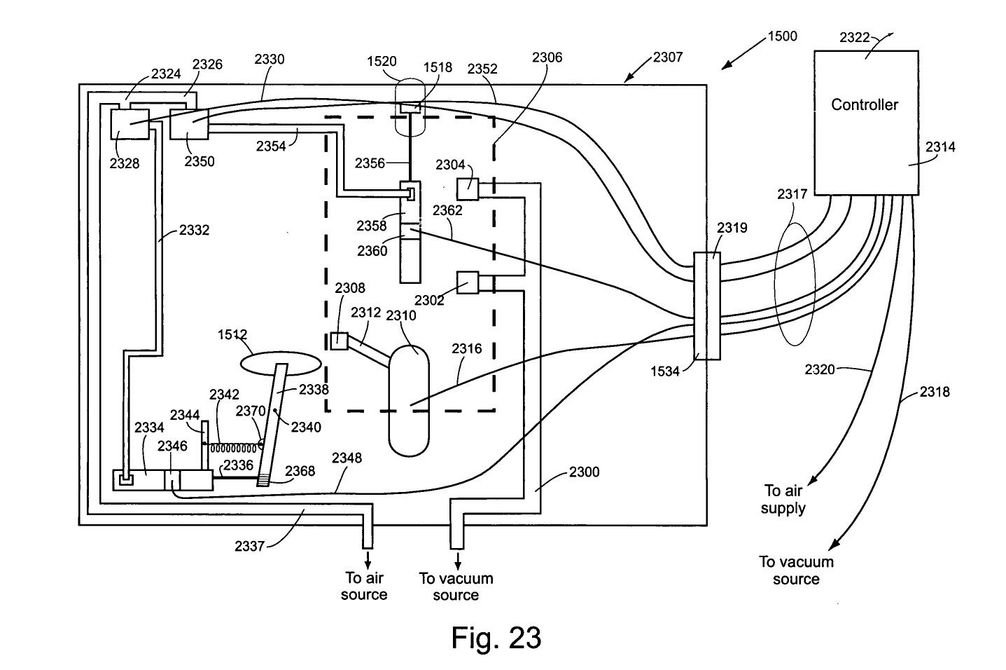

FIG. 23 shows one embodiment of a retaining device that is optionally included in a container station of the invention. A vacuum source (not shown) connects to vacuum line 2300 which connects to vacuum inlets 2302 and 2304. The vacuum line inlets 2302 and 2304 are directly connected into vacuum openings or holes which extend through the vacuum plate and communicate with the vacuum groove. In a preferred embodiment, the vacuum holes are positioned adjacent the perimeter of the vacuum plate and use a vacuum groove to communicate the vacuum around the perimeter of the vacuum plate. It will be appreciated that other positioning of the vacuum holes and other arrangements can be used to improve the vacuum sealing capability of the vacuum plate.

Multi-well containers and objects sometimes have lower surface imperfections that can interfere with the formation of an airtight seal between the vacuum plate and the object surface. Such imperfections can include, for example, warping, height variations, and other structural imperfections. For example, the bottom surface of a microtiter plate may bow slightly so that the center portion of the microtiter plate extends below the perimeter edge of the microtiter plate. Accordingly, if such a bowed plate is placed on vacuum plate 1504, the bowed portion of the microtiter plate can contact interior plate area 1526 and not allow a perimeter edge of the plate to fully engage lip area 1528. In this manner, when vacuum is applied to vacuum channel 1530, a gap sufficient to avoid vacuum sealing may remain between the perimeter edge of the microtiter plate and lip area 1528. With such a gap, it may not be possible to vacuum seal the microtiter plate to the vacuum plate.

To accommodate such imperfections in microtiter plates and other objects, the interior vacuum surface 1526 may be recessed slightly below the vacuum lip 1528. By recessing the interior surface 1526 slightly, the probability that the perimeter edge of the microtiter plate will fully contact lip area 1528 is increased. The depth and other dimensions of the recess will depend upon the expected variations in the bottom surface of the objects. Typically, the depth of the recess is between about 0.001 and 0.01 inches. For microtiter plates, the interior vacuum area is preferably positioned about 0.002 inches below the top surface of lip 1528 because it has been found that the 0.002-inch variation in height is not sufficient to disrupt the sample wells when the microtiter plate is sealed to the vacuum plate 1504. Another approach by which to avoid distortion of the object, the recessed area can be partially or completely filled with a porous matrix material or other support members (e.g., ribs) that provide support for the bottom surface of the object while still allowing formation of a vacuum seal. The use of a support allows the use of a recess of greater depth, if desired.

The retaining devices of the invention can also include sensing switches or other means for sensing whether a vacuum effect is present between an object and the vacuum plate. For example, FIG. 16 shows vacuum switch hole 1532, which in this particular embodiment is positioned at the base of the vacuum groove 1530. The vacuum switch hole communicates the vacuum level to a vacuum sensing switch, which confirms a sufficient level of vacuum beneath the object. In such a manner, the vacuum force retaining the multi-well container can be measured and monitored while the container is retained against the vacuum plate 1504. If the vacuum level is insufficient, the sensing switch can send a signal to a controller, or to a human operator, that the container is not properly positioned and/or retained and thus is not ready for further processing. Conversely, if a vacuum is sensed, the switch can signal the controller to proceed with further processing.

An example of a retaining device that includes a sensing device is shown in FIG. 23, which generally shows a bottom side of a support surface with vacuum plate 1504 positioned on the top surface of the support surface. Although from the bottom view in FIG. 23 the vacuum plate is not visible, dotted line 2306 shows the general positioning of the vacuum plate on the other side of the support surface. As shown, a vacuum switch hole is positioned in the vacuum groove. The vacuum switch hole communicates with vacuum switch inlet 2308, which connects to vacuum switch 2310 through vacuum switch line 2312. Vacuum switch 2310 electrically connects to controller 2314 through control line 2316 for communicating status of vacuum to controller 2314. In that regard, controller 2314 receives a signal when sufficient vacuum is achieved at the vacuum plate to draw the microtiter plate firmly against the vacuum plate. Controller 2314 can also communicate to the vacuum source via control line 2318 and optionally to a air supply source (described below) via control line 2320. Controller 2314 can also receive direction and send status information to other system components via system connection line 2322. Controllers are described further below.

Once the vacuum source has securely retained the microtiter plate or other object against the vacuum plate, additional processes (e.g., material transfer, etc.) may be performed reliably and accurately in the microtiter plate. When processing of the microtiter plate or other object is completed, the vacuum source is deactivated to release the object from the vacuum plate.

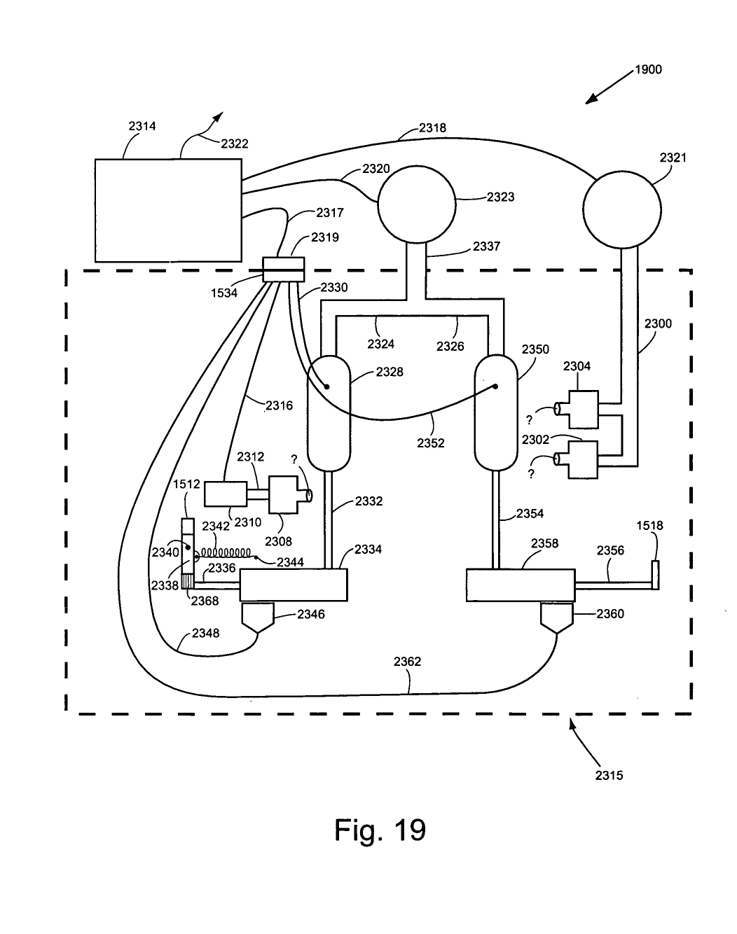

The positioning devices of the invention typically have a control system that coordinates the actions of the different components of the device or system that includes the device. FIG. 19 shows one example of control system 1900 for container station 1900 of a positioning device of the invention. Control system 1900 generally comprises controller 2314 connected to container station 2315 through control line 2317. Control line 2317 may terminate in connector 2319 to facilitate connection to mating control connector 1534 on container station 2315. This arrangement facilitates connection and disconnection of the components. Controller 2314 may also be connected to other system components in a high throughput test system through, e.g., system connection line 2322. For example, the controller 2314 matrices instructions from a central control system and reports status information in return.

Controller 2314 in this embodiment also controls vacuum source 2321 through vacuum source control line 2318 and optionally controls an air supply 2323 via air supply control line 2320. In such a manner, the controller can accept instructions or send status information to a high throughput test system controller and control and monitor the precise positioning of a microtiter plate.

In some embodiments, both x-axis pusher 1518 and y-axis pusher 1512 are activated by air pistons. Air supply 2323 provides pressurized air through air supply line 2320 which is directed into y-axis air supply line 2324 and x-axis air supply line 2326. Y-axis air supply line 2324 is received into y-axis air switch 2328 which acts as a valve to open or close y-axis supply line 2324. The y-axis air switch is directed by the controller 2314 through x-axis air switch control line 2330. When controller 2314 directs y-axis air switch 2328 to an open position, air pressure is received into y-axis piston air supply line 2332. Y-axis piston air supply line 2332 is connected to y-axis air piston 2334, which drives y-axis arm 2336. It will be appreciated that other mechanisms may be used to activate the pushers, such as hydraulic rams, electromagnetic actuators, or gear drives, for example.

Y-axis arm 2336 drives lever 2338 around pivot 2340. Accordingly, when air piston 2334 is activated, y-axis pusher pin 1512 is moved from its at-rest position. The at-rest position is defined by spring 2342 which attaches between lever 2338 and spring support 2344. In such a manner spring 2342 causes lever 2338 to pivot from pivot point 2340. In a preferred embodiment, when air piston 2334 is not active, the spring causes y-axis pusher 1512 to be firmly engaged against the microtiter plate. Accordingly, when air piston 2334 is activated, y-axis pusher 1512 is moved away from a wall of the microtiter plate.

Air piston 2334 has y-axis magnet switch 200 that communicates y-axis arm position 2336 to controller 2314 via magnetic switch control line 2348. In such a manner the controller receives a signal indicating the status of the position of y-axis arm 2336. For example, a signal may be placed on line 2348 when air piston 2334 has moved y-axis arm 2336 in a position that fully disengages y-axis pusher 1512 from the microtiter plate.

X-axis air switch 2350 is connected to controller 2314 through x-axis air switch control line 2352. When controller 2314 directs x-axis air switch 2350 to activate, air pressure is placed in x-axis piston air supply line 2354. Such air pressure drives x-axis arm 2356 of x-axis air piston 2358. X-axis magnetic switch 2360 communicates to controller 2314 through magnetic switch control line 2362 to generate a signal that indicates the position of x-axis arm 2356. In a preferred example, x-axis air piston 2358 is configured to retract x-axis pusher 1518 when air piston 2358 is deactivated and to force x-axis pusher 1518 against the microtiter plate when the x-axis air piston 2358 is activated. When x-axis air piston 2358 is activated and x-axis pusher 1518 is driven against the microtiter plate, magnetic switch 2360 typically generates a signal on line 2362 which indicates to the controller 2314 that the microtiter plate is positioned along the x-axis.

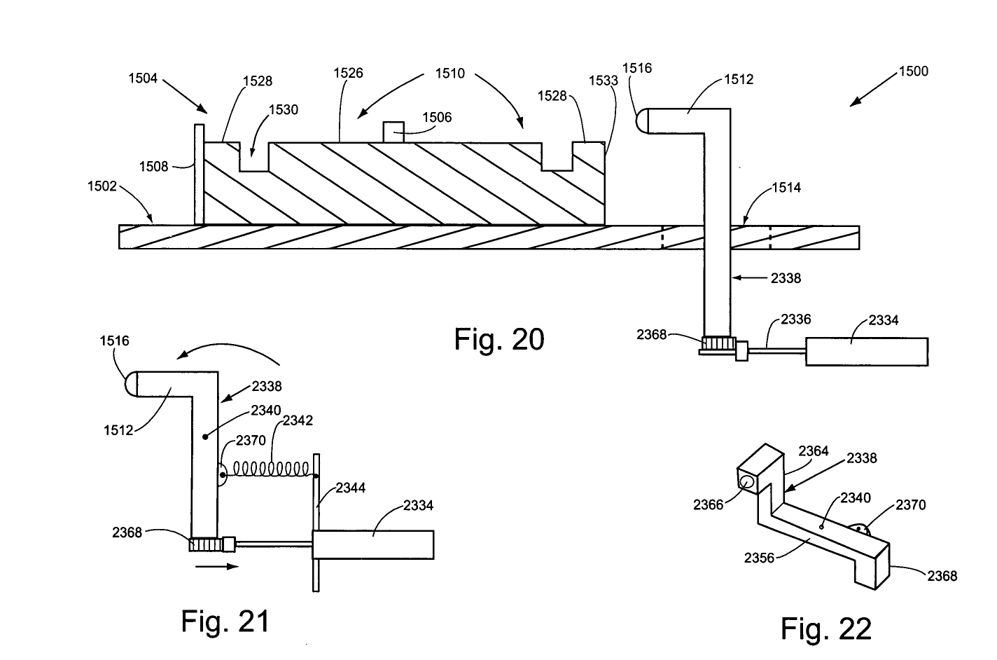

Referring now to FIGS. 20-22, the operation of one embodiment of a y-axis pusher is detailed. The y-axis pusher in this embodiment is a generally L-shaped member having vertical portion 2364 and horizontal portion 2356. Contact connector 2366 is positioned at the top end of vertical portion 2364 for attaching plate contact 1516. Horizontal portion 2356 extends at a right angle from vertical portion 2364 and ends with enlarged arm contact 2368. Arm contact 2368 is constructed and arranged to cooperate with y-axis arm 2336 of y-axis piston 2334. In a preferred embodiment, y-axis arm 2336 terminates with an adjustment mechanism for adjusting the length of y-axis arm 2336.

Horizontal portion 2356 of lever 2338 has pivot 2340 for receiving a pivot pin that enables y-axis pusher 1512 to pivot about pivot point 2340. Horizontal portion 2356 also has spring connector 2370 for receiving one end of spring 2342. The other end of spring 2342 is connected to a stable support such as stable support 2344. In a preferred configuration, spring support 2344 is attached to the y-axis air piston and the support structure of the positioning device. When spring 2342 is connected between spring contact 2370 and stable support 2344, the spring acts to draw arm contact 2368 towards air piston 2334. As in the illustrated example the lever 2338 is configured to pivot about pivot point 2340, the plate contact 1516 is rotated in a direction generally away from the air piston.

In the illustrated embodiment, when air piston 2334 is not activated, spring 2342 acts to press plate contact 1516 toward y-axis wall 1533 of vacuum plate 1504. If a microtiter plate (not shown in FIGS. 20-22) is generally positioned on the vacuum plate 1504, plate contact 1516 contacts a y-axis wall of the microtiter plate and pushes the plate toward y-axis protrusions 1508. For optimum positioning performance, y-axis pusher 1512 should provide a constant and stable positioning force to the y-axis wall of a microtiter plate. To assure a constant pressure, the force exerted by y-axis pusher 1512 is determined by the spring 2342. As springs typically provide a constant force, the microtiter plate will be positioned with a known and constant tensioning force.

In preferred embodiments, after the microtiter plate is positioned relative to the y-axis, the y-axis pusher continues to exert a force against the y-axis wall of the microtiter plate. When the x-axis pusher is activated, the x-axis pusher 1518 moves the microtiter plate towards the x-axis protrusion 1506. Accordingly, the microtiter plate is moved relative the plate contact and the lever 2338 while the y-axis pusher continues to exert a force against the microtiter plate. More specifically, levers 2338 typically maintain stability in the x-axis direction to avoid skewing and maintain a constant and stable y-axis force. To achieve such stability for lever 2338, lever 2338 is constructed as a pivoting lever which pivots about pivot point 2340. Since pivot point 2340 and the plate contact are generally aligned with the x-axis of the microtiter plate, the pivot acts to substantially stabilize the x-axis positioning of the plate contact 1516. Accordingly, when y-axis pusher 1512 is fully pressed against the microtiter plate, and x-axis pusher 1518 moves the microtiter plate towards x-axis protrusion 1506, y-axis pusher 1512 maintains a constant and stable y-axis force. Skewing is also avoided by constructing the plate contact 1516 to have a low-friction contact point with the microtiter plate.

Although in preferred embodiments, the y-axis pusher is configured as a pivoting lever, it will be appreciated that other configurations may be used to move a microtiter plate towards y-axis protrusions. For example, plate contact 1516 could be directly attached to an air piston arm with the air piston being driven by a constant and stable air force to move the plate contact stably and constantly toward the microtiter plate wall. Some of these embodiments are described above and schematically illustrated in, e.g., FIG. 1.

Once the vacuum source has securely retained the microtiter plate against vacuum plate 1504, additional processes may be performed reliably and accurately to the microtiter plate. When processing of the microtiter plate is completed, the vacuum source is deactivated to release the microtiter plate from the vacuum plate 1504. In this process, both x-axis pusher 1518 and y-axis pusher 1512 are released. With the vacuum off and the pushers released, the microtiter plate can be easily lifted from the positioning device, e.g., manually, using a robotic translocation device, or the like for further processing.

Referring further to FIG. 23, which schematically depicts one exemplary arrangement of container station components for a positioning device according to one embodiment of the invention. FIG. 23 generally shows a bottom side of support structure 2307 with vacuum plate 1504 positioned on the top surface of support structure 2307. Although from the bottom view in FIG. 23, vacuum plate 1504 is not visible, dotted line 2306 shows the general positioning of vacuum plate 1504 on the other side of support structure 2307.

An air source (not shown) is connected to air supply 2337 which runs generally on the perimeter of support structure 2307 to y-axis air supply line 2324 and x-axis air supply line 2326. Y-axis air supply line 2324 connects to y-axis air switch 2328 and x-axis air supply line 2326 connects to x-axis air switch 2350. Air switches 2328 and 2350 electrically connect via electrical lines 2330 and 2352 to electrical connector 1534, and then connect to controller 2314 through connector 2319 and control line 2317. Accordingly, controller 2314 can then direct the air switches to activate or deactivate the air pistons. For example, controller 2314 can direct y-axis air switch 2328 to activate, thereby pressurizing y-axis air supply line 2332 and driving the arm 2336 of air piston 2334. When arm 2336 is driven, lever 2338 pivots about pivot point 2340 and pulls y-axis pusher lever away from the vacuum plate. When controller 2322 deactivates y-axis air switch 2328, air bleeds from piston 2334 and spring 2342, which is under tension between spring contact 2370 and stable support 2344, tensions the y-axis pusher towards the vacuum plate. Magnetic switch 2346 communicates to controller 2314 through control line 2348 for indicating y-axis pusher position.

Controller 2314 also controls x-axis air switch 2350, which when opened pressurizes x-axis piston air supply line 2354 for driving x-axis arm 2356 of x-axis air piston 2360. Accordingly, x-axis pusher 1518 is propelled toward vacuum plate 1504. In a preferred embodiment, x-axis pusher 1518 is directly attached to x-axis arm 2356. It will be appreciated that other configurations and arrangements may be used for attaching the x-axis pusher to the x-axis arm. For example, certain of these other embodiments are described further above. To conserve space, the x-axis piston is arranged so that arm 2356 is pulled into piston body 2358 when air pressure is applied to piston 2358. When pressure is released, arm 2356 travels in a manner so that x-axis pusher 1518 is released from any retained microtiter plate. Magnetic switch 2360 connects to controller 2314 via line 2362 so that controller 2314 can receive a signal that x-axis pusher 1518 is fully engaged against the microtiter plate.

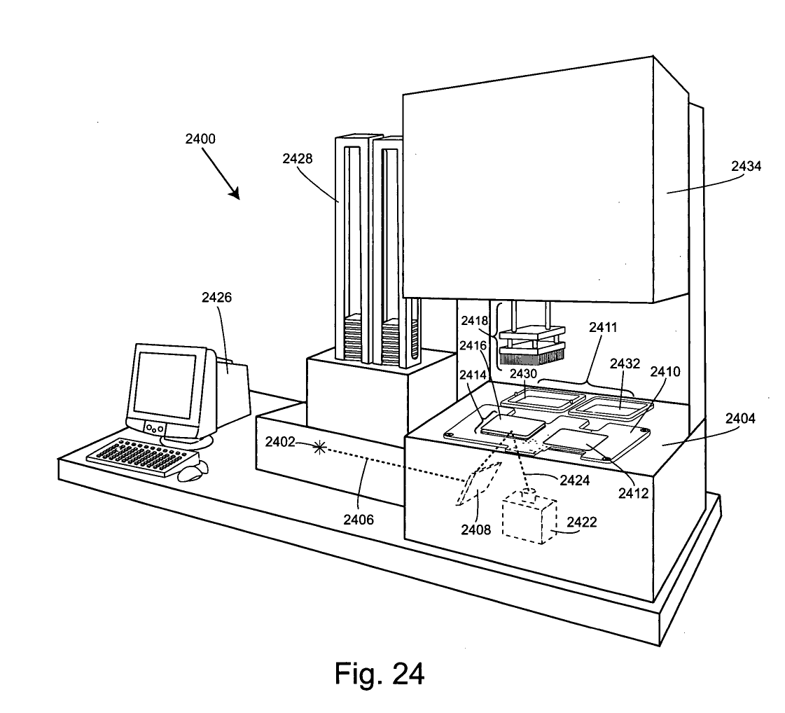

FIG. 24 schematically illustrates an automated system from a perspective view according to one embodiment of the invention. As shown, system 2400 includes electromagnetic radiation source 2402, which is schematically depicted as a laser. Other electromagnetic radiation sources are also optionally adapted for use in the systems of the invention, including electroluminescence devices, laser diodes, light-emitting diodes (LEDs), incandescent lamps, arc lamps, flash lamps, fluorescent lamps, and the like. System 2400 also includes sample assaying region 2404, which is configured to receive source electromagnetic radiation 2406 from electromagnetic radiation source 2402 via mirror 2408. Various optical systems are optionally utilized or adapted for use in the systems of the invention. Exemplary optical systems are described or referred to herein. Other suitable optical systems are known in the art and will be apparent to those of skill.

In preferred embodiments, sample assaying region 2404 includes container positioning device 2410, which includes container stations 2412 and 2414 that are each structured to position multi-well container 2416 relative to material handling device 2418. Sample assaying region 2404 also includes transfer probe washing station 2411, which includes wash reservoirs 2430 and 2432 for washing components of material handling device 2418. Material handling device 2418 is configured to transfer fluid in at least one selected region (e.g., sample assaying region 2404, as shown) of system 2400. As also shown, system 2400 also includes detector 2422 configured to detect sample electromagnetic radiation 2424 received from sample assaying region 2404. Various detectors are optionally adapted for use in the systems of the invention including, e.g., charge-coupled devices (CCDs), intensified CCDs, photomultiplier tubes (PMTs), photodiodes, avalanche photodiodes, etc. Hood 2434 of system 2400 moves to enclose sample assaying region 2404 to exclude, e.g., electromagnetic radiation other than source and sample electromagnetic radiation 2406 and 2424, respectively, or other contaminates that may bias assay results from sample assaying region 2404.

System 2400 also includes controller 2426 (shown as computer) that is typically operably connected to, e.g., electromagnetic radiation source 2402, material handling device 2418, and detector 2422. Optionally, controller 2426 is also operably connected to other system components. The controllers of the invention typically include at least one logic device (e.g., a computer such as the one illustrated in FIG. 24) having one or more logic instructions that direct operation of one or more components of the system. Also shown is multi-well container storage component 2428, which stores containers before and/or after being assayed. Other components such as container incubation components and robotic devices among others are also optionally included in the systems of the invention. All of these system components are described in greater detail below.

The automated systems of the invention are typically configured to detect and quantify absorbance, transmission, and/or emission (e.g., luminescence, fluorescence, etc.) of light, and/or changes in those properties in samples that are arrayed in the wells of a multi-well plate or other multi-well container. Alternatively, or simultaneously, detectors can quantify any of a variety of other signals from the multi-well containers including chemical signals (e.g., pH, ionic conditions, or the like), heat (e.g., for monitoring endothermic or exothermic reactions, e.g., using thermal sensors) or any other suitable physical phenomenon. In addition to other system components described herein, the assaying systems of the invention also generally include illumination or electromagnetic radiation sources, optical systems, and detectors. Because the systems and methods of the invention are flexible and allow essentially any chemistry to be assayed, they can be used for all phases of assay development, including prototyping and mass screening.

In preferred embodiments, the systems of the invention are configured for area imaging, but can also be configured for other formats including as a scanning imager or as a nonimaging counting system. An area imaging system typically places an entire multi-well container or other specimen onto the detector plane at one time. Accordingly, there is typically no need to move photomultiplier tubes (PMTs), to scan a laser, or the like, because the detector images the entire container onto many small detector elements (e.g., charge-coupled devices (CCDs), etc.) in parallel. This parallel acquisition phase is typically followed by a serial process of reading out the entire image from the detector. Scanning imagers typically pass a laser or other light beam over the specimen, to excite fluorescence, reflectance, or the like in a point-by-point or line-by-line fashion. In certain cases, confocal-optics are used to minimize out of focus fluorescence. The image is constructed over time by accumulating the points or lines in series. Nonimaging counting systems typically use PMTs or light sensing diodes to detect alterations in the transmission or emission of light, e.g., within wells of a multi-well container. These systems then typically integrate the light output from each well into a single data point.

A wide variety of illumination or electromagnetic sources and optical systems can be adapted for use in the systems of the present invention. Accordingly, no attempt is made herein to describe all of the possible variations that can be utilized in the systems of the invention and which will be apparent to one skilled in the art. Exemplary electromagnetic radiation sources that are optionally utilized in the systems of the invention include, e.g., lasers, laser diodes, electroluminescence devices, light-emitting diodes, incandescent lamps, arc lamps, flash lamps, fluorescent lamps, and the like. One preferred type of laser used in the assaying systems of the invention are argon-ion lasers. Exemplary optical systems that conduct electromagnetic radiation from electromagnetic radiation sources to sample containers and/or from multi-well containers to detectors typically include one or more lenses and/or mirrors to focus and/or direct the electromagnetic radiation as desired. Many optical systems also include fiber optic bundles, optical couplers, filters (e.g., filter wheels, etc.), and the like.

Suitable signal detectors that are optionally utilized in these systems detect, e.g., emission, luminescence, transmission, fluorescence, phosphorescence, absorbance, or the like. In preferred embodiments, the detector monitors a plurality of optical signals, which correspond in position to “real time” results. Example detectors or sensors include PMTs, CCDs, intensified CCDs, photodiodes, avalanche photodiodes, optical sensors, scanning detectors, or the like. Each of these as well as other types of sensors is optionally readily incorporated into the systems described herein. The detector optionally moves relative to multi-well plates or other assay components, or alternatively, multi-well plates or other assay components move relative to the detector. In certain embodiments, for example, detection components are coupled to translation components that move the detection components relative to multi-well plates positioned on container positioning devices of the systems described herein. Optionally, the systems of the present invention include multiple detectors. In these systems, such detectors are typically placed either in or adjacent to, e.g., a multi-well plate or other vessel, such that the detector is in sensory communication with the multi-well plate or other vessel (i.e., the detector is capable of detecting the property of the plate or vessel or portion thereof, the contents of a portion of the plate or vessel, or the like, for which that detector is intended). In preferred embodiments, detectors are configured to detect electromagnetic radiation originating in the wells of a multi-well container.

The detector optionally includes or is operably linked to a computer, e.g., which has system software for converting detector signal information into assay result information or the like. For example, detectors optionally exist as separate units, or are integrated with controllers into a single instrument. Integration of these functions into a single unit facilitates connection of these instruments with the computer, by permitting the use of a few or even a single communication port for transmitting information between system components. Computers and controllers are described further below. Detection components that are optionally included in the systems of the invention are described further in, e.g., Skoog et al., Principles of Instrumental Analysis, 5^{th} Ed., Harcourt Brace College Publishers (1998) and Currell, Analytical Instrumentation: Performance Characteristics and Quality, John Wiley & Sons, Inc. (2000), which are incorporated by reference in their entirety.

Additional details relating to electromagnetic radiation sources, optical systems, detectors, and other aspects of the present invention which can be utilized or adapted for use in the systems described herein are provided in, e.g., U.S. Pat. Nos. 6,316,774, entitled “OPTICAL SYSTEM FOR A SCANNING FLUOROMETER,” which issued Nov. 13, 2001 to Giebeleret al., U.S. Pat. No. 5,112,134, entitled “SINGLE SOURCE MULTI-SITE PHOTOMETRIC MEASUREMENT SYSTEM,” which issued May 12, 1992 to Chow et al., U.S. Pat. No. 5,766,875, entitled “METABOLIC MONITORING OF CELLS IN A MICROPLATE READER,” which issued Jun. 16, 1998 to Hafeman et al., U.S. Pat. No. 6,469,311, entitled “DETECTION DEVICE FOR LIGHT TRANSMITTED FROM A SENSED VOLUME,” which issued Oct. 22, 2002 to Modlin et al., U.S. Pat. No. 6,151,111, entitled “PHOTOMETRIC DEVICE,” which issued Nov. 21, 2000 to Wechsler et al., U.S. Pat. No. 6,498,690, entitled “DIGITAL IMAGING SYSTEM FOR ASSAYS IN WELL PLATES, GELS AND BLOTS,” which issued Dec. 24, 2002 to Ramm et al., and U.S. Pat. No. 6,313,471, entitled “SCANNING FLUOROMETER,” which issued Nov. 6, 2001 to Giebeler et al.

As referred to above, the automated systems of the invention also typically include controllers that are operably connected to one or more components (e.g., positioning device components, electromagnetic radiation sources, material handling devices, detectors, valves, pumps, fluid sensors, robotic translocation devices, etc.) of the systems to control operation of the components. More specifically, controllers are generally included either as separate or integral system components that are utilized, e.g., to regulate the intensity and/or wavelength of electromagnetic radiation emitted from the electromagnetic radiation source, the movement of material transfer devices, the detection of electromagnetic radiation received from sample containers by the detector, etc. Controllers and/or other system components is/are optionally coupled to an appropriately programmed processor, computer, digital device, or other logic device or information appliance (e.g., including an analog to digital or digital to analog converter as needed), which functions to instruct the operation of these instruments in accordance with preprogrammed or user input instructions, receive data and information from these instruments, and interpret, manipulate and report this information to the user.

Any controller or computer optionally includes a monitor which is often a cathode ray tube (“CRT”) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user. An exemplary computer is schematically illustrated in FIG. 24.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation, e.g., varying or selecting the rate or mode of movement of various system components, directing translation of robotic gripping devices and material handling devices, or the like. The computer then receives the data from, e.g., sensors/detectors included within the system, and interprets the data, either provides it in a user understood format, or uses that data to initiate further controller instructions, in accordance with the programming, e.g., such as in monitoring detectable signal intensity, multi-well container positioning, or the like.

More specifically, the software utilized to control the operation of the systems of the invention typically includes logic instruction instructions that direct, e.g., the material transfer device to transfer material (e.g., fluidic material) between containers, the pushers of the positioning device to push the containers into contact with the alignment members when the containers are positioned in a container station, a robotic handling device to translocate containers, and/or the like.

The computer can be, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX-based machine, a MACINTOSH™, Power PC, or a UNIX-based (e.g., SUN™ work station) machine) or other common commercially available computer which is known to one of skill. Standard desktop applications such as word processing software (e.g., Microsoft Word™ or Corel WordPerfect™) and database software (e.g., spreadsheet software such as Microsoft Excel™, Corel Quattro Pro™, or database programs such as Microsoft Access™ or Paradox™) can be adapted to the present invention. Software for performing, e.g., fluid transfer to selected wells of a multi-well plate, assay detection, and data deconvolution is optionally constructed by one of skill using a standard programming language such as Visual basic, Fortran, Basic, Java, or the like.

The systems of the invention optionally further include various container incubation components, multi-well container washing components, and/or container storage components. In some embodiments, for example, systems include incubation components that are structured to incubate or regulate temperatures within multi-well plates. To illustrate, many cell-based or other types of assays include incubation steps and can be performed using these systems. Additional details regarding incubation devices that are optionally adapted for use with the systems of the present invention are described in, e.g., International Publication No. WO 03/008103, entitled “HIGH THROUGHPUT INCUBATION DEVICES,” filed Jul. 18, 2002 by Weselak et al., which is incorporated by reference in its entirety. Optionally, the systems of the invention include components for washing the wells of multi-well containers, many of which are widely known in the art. In preferred embodiments, these components non-invasively wash or otherwise remove material from the wells of multi-well containers. Additional details relating to non-invasive washing devices and methods are provided in, e.g., U.S. Provisional Patent Application No. 60/461,638, entitled “MATERIAL REMOVAL DEVICES, SYSTEMS, AND METHODS,” filed Apr. 8, 2003 by Micklash II, et al., which is incorporated by reference in its entirety. In certain embodiments, the sample assaying systems of the invention include multi-well plate storage components that are structured to store one or more multi-well plates. Such storage components typically include multi-well plate hotels or carousels that are known in the art and readily available from various commercial suppliers, such as Beckman Coulter, Inc. (Fullerton, Calif.). For example, in one embodiment, a system of the invention includes a stand-alone station in which a user loads a number of multi-well plates to be assayed into one or more storage components of the system for automated processing of the plates. In these embodiments, the systems of the invention also typically include one or more robotic translocation or gripper devices that move plates, e.g., between incubation or storage components and positioning devices. Robotic grippers that are suitable for use in the systems of the invention are described further below or otherwise known in the art. For example, a TECAN® robot, which is commercially available from Clontech (Palo Alto, Calif.), is optionally adapted for use in the systems described herein. An exemplary container storage component is schematically shown in FIG. 24.

The systems of the invention optionally also include at least one robotic translocation or gripping component that is structured to grip and translocate multi-well plates between components of the automated systems and/or between the systems and other locations (e.g., other work stations, etc.). In certain embodiments, for example, systems further include gripping components that move multi-well plates between positioning components, incubation components, etc. A variety of available robotic elements (robotic arms, movable platforms, etc.) can be used or modified for use with these systems, which robotic elements are typically operably connected to controllers that control their movement and other functions. Exemplary robotic gripping devices that are optionally adapted for use in the systems of the invention are described further in, e.g., International Publication No. WO 02/068157, entitled “GRIPPING MECHANISMS, APPARATUS, AND METHODS,” filed Feb. 26, 2002 by Downs et al., which is incorporated by reference in its entirety. A representative robotic translocation device is schematically depicted in, e.g., FIG. 1.

System components (e.g., positioning device components, material handling device components, washing station components, etc.) are optionally formed by various fabrication techniques or combinations of such techniques including, e.g., machining, stamping, engraving, injection molding, cast molding, embossing, extrusion, etching (e.g., electrochemical etching, etc.), or other techniques. These and other suitable fabrication techniques are generally known in the art and described in, e.g., Altintas, Manufacturing Automation: Metal Cutting Mechanics, Machine Tool Vibrations, and CNC Design, Cambridge University Press (2000), Molinari et al. (Eds.), Metal Cutting and High Speed Machining, Kluwer Academic Publishers (2002), Stephenson et al., Metal Cutting Theory and Practice, Marcel Dekker (1997), Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000). In certain embodiments, following fabrication system components are optionally further processed, e.g., by coating surfaces with a hydrophilic coating, a hydrophobic coating (e.g., a Xylan 1010DF/870 Black coating available from Whitford Corporation (West Chester, Pa.), etc.), or the like, e.g., to prevent interactions between component surfaces and reagents, samples, or the like.

System component fabrication materials are generally selected according to properties, such as reaction inertness, durability, expense, or the like. In preferred embodiments, components are fabricated from various metallic materials, such as stainless steel, anodized aluminum, or the like. Optionally, system components are fabricated from polymeric materials such as, polytetrafluoroethylene (TEFLON™), polypropylene, polystyrene, polysulfone, polyethylene, polymethylpentene, polydimethylsiloxane (PDMS), polycarbonate, polyvinylchloride (PVC), polymethylmethacrylate (PMMA), or the like. Polymeric parts are typically economical to fabricate, which affords disposability. Component parts are also optionally fabricated from other materials including, e.g., glass, silicon, or the like.

In other aspects, the invention provides methods of positioning multi-well containers. The methods generally include providing a positioning device as described herein. The methods also typically include manually and/or robotically placing the multi-well containers in selected container stations of the positioning device. For positioning device embodiments that include container stations that are coupled to support structures by rotational couplings, the methods also generally include rotating the rotationally coupled container station about the rotational axis to a selected position. When a positioning device includes pushers and alignment members coupled to the support structure, the methods also typically include pushing the multi-well container into contact with the alignment members with the pushers to position the container.

In certain embodiments, openings are disposed in a container station and at least one vacuum source is operably connected to the openings. In these embodiments, the methods typically further include applying a vacuum at the openings with the vacuum source to hold the multi-well container in the container station. In preferred embodiments, the methods further include dispensing material (e.g., drug candidates and target molecules, samples comprising cells, combinatorial library members, labeled molecules, etc.) into and/or removing material from selected wells of the multi-well container with a material handling device, a non-invasive material removal device, or the like. In certain embodiments, the method further includes detecting one or more detectable signals produced in one or more selected wells of the multi-well container with a detector.

Essentially any biochemical or cellular assay can be adapted for performance in the systems of the invention. Exemplary assays optionally performed in the systems described herein include, e.g., intracellular calcium flux assays, membrane potential assays, nucleic acid hybridization assays among many others that are known in the art. Additional details relating to methods that are optionally performed using the devices and systems of the present invention are described in, e.g., Attorney Docket No. 36-002900US, entitled “NON-PRESSURE BASED FLUID TRANSFER IN ASSAY DETECTION SYSTEMS AND RELATED METHODS,” filed Aug. 4, 2003 by Evans et al., which is incorporated by reference in its entirety.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

1. A positioning device comprising a support structure having two or more container stations that each comprises a support surface that is structured to position at least one multi-well container, wherein:
wells of multi-well containers positioned in two or more of the container stations are accessible substantially simultaneously; and,
at least two of the container stations are tiered relative to one another.

2. The positioning device of claim 1, wherein at least one of the container stations comprises at least one orifice disposed through the positioning device, such that electromagnetic energy is receivable by and/or from at least a portion of one or more multi-well containers through the orifice when the multi-well containers are positioned in the container station.

3. The positioning device of claim 1, wherein one or more multi-well containers positioned in one tiered container station are accessible at least along a plane that is substantially parallel to top surfaces of the multi-well containers without contacting one or more other multi-well containers positioned in another tiered container station.

4. The positioning device of claim 1, wherein at least one of the container stations comprises a heating element that adjustably regulates temperature in one or more multi-well containers when the multi-well containers are positioned in the container station and the heating element is operably connected to a power source.

5. The positioning device of claim 1, further comprising at least one position sensor coupled to the support structure that is structured to detect the position of one or more multi-well containers when the multi-well containers are positioned in at least one of the container stations and/or to detect the position of at least one component of the positioning device.

6. The positioning device of claim 1, wherein at least one of the container stations is coupled to the support structure by a rotational coupling such that the container station is rotatable on the rotational coupling about at least one rotational axis.

7. The positioning device of claim 6, further comprising at least one rotational adjustment feature coupled to the support structure, which rotational adjustment feature engages the container station to adjustably rotate the container station about the rotational axis.

8. The positioning device of claim 1, wherein at least one of the container stations further comprises one or more openings disposed in the support surface of the container station through which a vacuum is applied to hold one or more multi-well containers in desired positions when the openings are operably connected to a vacuum source and the multi-well containers are positioned in the container station.

9. The positioning device of claim 8, wherein the container station comprises an interior surface and a lip surface, with the interior surface being recessed relative to the lip surface.

10. (canceled)

11. The positioning device of claim 9, wherein a support matrix approximately as thick as the depth at which the interior surface is recessed is present on the interior surface to prevent distortion of the multi-well containers when the vacuum is applied by the vacuum source.

12. The positioning device of claim 9, further comprising a vacuum-actuated switch that generates a signal that indicates the multi-well containers are properly positioned when the multi-well containers form airtight seals with the container station.

13. The positioning device of claim 12, further comprising at least one controller operably connected to the vacuum-actuated switch, wherein the signal notifies the controller that the multi-well containers are ready for further processing.

14. The positioning device of claim 1, wherein at least a first of the container stations comprises at least one alignment member that is positioned to engage an inner wall of an alignment member receiving area of at least a first multi-well container when the first multi-well container is on the support surface of the first container station.

15. The positioning device of claim 14, wherein the first container station comprises multiple alignment members extending from the support surface of the first container station and wherein at least two of the alignment members are positioned to engage different inner walls of the alignment member receiving area of the first multi-well container when the first multi-well container is positioned in the first container station.

16. The positioning device of claim 14, wherein the first container station comprises multiple alignment members that together form a nest that is structured to receive the first multi-well container when the first multi-well container is positioned in the first container station.

17. The positioning device of claim 16, wherein at least one of the multiplealignment members comprises an angled surface that is configured to direct the first multi-well container into the nest when the first multi-well container is placed into the nest.

18. The positioning device of claim 14, wherein the alignment member comprises a curved surface that is structured to engage the inner wall of the alignment member receiving area of the first multi-well container.

19. The positioning device of claim 18, wherein the alignment member comprises a locating pin that extends from the support surface of the first container station.

20. The positioning device of claim 14, further comprising one or more pushers coupled to the support structure, which pushers are configured to push the first multi-well container into contact with the alignment member when the first multi-well container is positioned in the first container station.

21. The positioning device of claim 20, wherein multiple pushers are coupled to the support structure and wherein at least two of the pushers are configured to push the first multi-well container in different directions.

22. The positioning device of claim 20, further comprising at least one controller operably connected to at least one of the pushers, which controller directs the pusher to push the first multi-well container into contact with the alignment member when the first multi-well container is positioned in the first container station.

23. (canceled)

24. (canceled)

25. The positioning device of claim 20, further comprising at least one lever arm pivotally coupled to the support structure by a pivotal coupling, wherein at least a first of the pushers is configured to push the lever arm such that the lever arm pivots to push the first multi-well container into contact with the alignment member when the first multi-well container is positioned in the first container station.

26. (canceled)

27. (canceled)

28. A positioning device comprising a support structure having one or more container stations that each comprises a support surface that is structured to position at least one multi-well container, wherein at least one of the container stations is coupled to the support structure by a rotational coupling such that the container station is rotatable on the rotational coupling about at least one rotational axis.

29-54. (canceled)

55. An automated system, comprising:
at least one positioning device that comprises a support structure having two or more container stations that each comprises a support surface that is structured to position at least one multi-well container, wherein wells of multi-well containers positioned in two or more of the container stations are accessible substantially simultaneously, and at least two of the container stations are tiered relative to one another;
at least one material handling device; and,
at least one controller operably connected to the material handling device, which controller directs the material handling device to dispense material into and/or remove material from selected wells of one or more multi-well containers when the multi-well containers are positioned in one or more container stations of the positioning device.

56. The automated system of claim 55, further comprising at least one robotic translocation device operably connected to the controller, which controller further directs the robotic translocation device to translocate selected multi-well containers to and/or from selected container stations.

57. The automated system of claim 55, further comprising at least one translational mechanism coupled to the positioning device, which translational mechanism is structured to translate the positioning device along at least one translational axis.

58. The automated system of claim 55, further comprising at least one multi-well container washing device operably connected to the controller, which controller further directs the multi-well container washing device to wash one or more selected wells of at least a first multi-well container when the first multi-well container is positioned in at least a first container station.

59. The automated system of claim 58, wherein the multi-well container washing device comprises a non-invasive multi-well container washing device.

60. The automated system of claim 55, wherein at least a first of the container stations further comprises at least one alignment member.

61. The automated system of claim 60, further comprising at least one pusher coupled to the support structure and operably connected to the controller, which controller further directs the pusher to push at least a first multi-well container into contact with the alignment member when the first multi-well container is positioned in the first container station.

62. The automated system of claim 55, further comprising at least one detector operably connected to the controller, which controller further directs the detector to detect one or more detectable signals produced in one or more selected wells of one or more multi-well containers when the multi-well containers are positioned in one or more container stations of the positioning device.

63. The automated system of claim 55, wherein the material handling device comprises a fluid handling device.

64. The automated system of claim 63, wherein fluid handling device comprises a pin tool and/or a pipettor.

65. The automated system of claim 55, wherein at least one of the container stations comprises one or more openings disposed in the container station and the system further comprises at least one vacuum source operably connected to the openings, which vacuum source applies a vacuum at the openings to hold at least one selected multi-well container in a desired position when the selected multi-well container is in the container station.

66. The automated system of claim 65, wherein the controller is further operably connected to the vacuum source to regulate the vacuum applied by the vacuum source.

67. The automated system of claim 55, wherein at least one of the container stations is coupled to the support structure by a rotational coupling such that the container station is rotatable on the rotational coupling about at least one rotational axis.

68. The automated system of claim 67, further comprising at least one rotational adjustment feature coupled to the support structure, which rotational adjustment feature engages the rotationally coupled container station to adjustably rotate the rotationally coupled container station about the rotational axis.

69. The automated system of claim 68, wherein the controller is further operably connected to the rotational adjustment feature to further direct the rotational adjustment feature to adjustably rotate the rotationally coupled container station.

70-97. (canceled)
